(19) United States
(12) Patent Application Publication
(10) Pub. No.: US 2026/0153941 A1
(43) Pub. Date: Jun. 4, 2026

(54) ELECTRONIC DEVICE AND METHOD FOR IDENTIFYING PRESSURE ON BUTTON

(71) Applicant: Samsung Electronics Co., Ltd., Suwon-si (KR)

(72) Inventors: Byoungjun KIM, Suwon-si (KR); Intae JUN, Suwon-si (KR); Daewon KANG, Suwon-si (KR); Jooyeol RYU, Suwon-si (KR); Shinhyuk YOON, Suwon-si (KR); Eunbi LEE, Suwon-si (KR); Jinwook CHUN, Suwon-si (KR); Sunyong CHOI, Suwon-si (KR); Hyunchul HONG, Suwon-si (KR); Byounguk YOON, Suwon-si (KR)

(21) Appl. No.: 19/335,910

(22) Filed: Sep. 22, 2025

Related U.S. Application Data
(63) Continuation of application No. PCT/KR2025/013199, filed on Aug. 28, 2025.

(30) Foreign Application Priority Data
Dec. 2, 2024 (KR) 10-2024-0176921
Jan. 15, 2025 (KR) 10-2025-0006417

(51) Int. Cl. G06F 3/02; B06B 1/06; G06F 3/01

(52) U.S. Cl. CPC G06F 3/0227; B06B 1/0688; G06F 3/016

(57) ABSTRACT

An electronic device includes a first button, a second button, at least one processor, comprising processing circuitry, a pressure sensor configured to provide a first signal to the at least one processor, a piezo actuator configured to output a vibration via the first button, and memory storing instructions. The instructions, when executed by at least one processor individually or collectively, cause the electronic device to: based on receiving a second signal from the piezo actuator, while the first signal is not provided to the at least one processor from the pressure sensor, detect a malfunction associated with the first button, and based on the malfunction associated with the first button, in response to the second signal and a third signal indicating a pressure on the second button being maintained during reference time, execute a function allocated to a combination of the pressure on the first button and a pressure on the second button.

### CROSS-REFERENCE TO RELATED APPLICATIONS

This application is a continuation of International Application No. PCT/KR2025/013199 designating the United States, filed on Aug. 28, 2025, in the Korean Intellectual Property Receiving Office and claiming priority to Korean Patent Application Nos. 10-2024-0176921, filed on Dec. 2, 2024, and 10-2025-0006417, filed on Jan. 15, 2025, in the Korean Intellectual Property Office, the disclosures of each of which are incorporated by reference herein in their entireties.

### BACKGROUND

### Field

The disclosure relates to an electronic device for identifying a pressure on a button.

### Description of Related Art

An electronic device such as a smartphone may include a button for receiving a user input. The button may be implemented to be physically pressed on a side surface of the electronic device. Based on an electrical signal according to a pressure on the button, various functions such as volume adjustment, toggling of a normal mode and a silent mode, power on/off, or screen lock may be provided.

The above-described information may be provided as a related art for the purpose of helping understanding of the present disclosure. No assertion or determination is made as to whether any of the above description may be applied as a prior art related to the present disclosure.

### SUMMARY

According to an embodiment, an electronic device may include: a housing defining an exterior of the electronic device, a first button protruding from a portion of the housing or defined on a portion of the housing, a second button protruding from another portion of the housing or defined on another portion of the housing, at least one processor including processing circuitry, a pressure sensor configured to provide a first signal to the at least one processor based on a pressure on the first button, a piezo actuator configured to output a vibration via the first button based on the pressure on the first button, and memory comprising one or more storage media, storing instructions. The instructions, when executed by the at least one processor individually or collectively, may cause the electronic device to, based on receiving a second signal from the piezo actuator, while the first signal is not provided to the at least one processor from the pressure sensor, detect a malfunction associated with the first button, and based on the malfunction associated with the first button, in response to the second signal and a third signal indicating a pressure on the second button being maintained during reference time, execute a function allocated to a combination of the pressure on the first button and a pressure on the second button.

According to an embodiment, a method performed by an electronic device may include based on receiving a second signal from a piezo actuator configured to output a vibration via the first button based on the pressure on the first button, while a first signal is not provided to at least one processor of the electronic device from a pressure sensor configured to provide the first signal to the at least one processor based on a pressure on a first button of the electronic device, detecting a malfunction associated with the first button, and based on the malfunction associated with the first button, in response to the second signal and a third signal indicating a pressure on a second button of the electronic device being maintained during reference time, executing a function allocated to a combination of the pressure on the first button and a pressure on the second button.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram of an electronic device in a network environment according to various embodiments;

FIG. 2A is a diagram indicating an example electronic device according to various embodiments;

FIG. 2B is an exploded perspective view of an example electronic device according to various embodiments;

FIG. 3A is a diagram illustrating an example of buttons included in an electronic device according to various embodiments;

FIG. 3B is a diagram illustrating an example operation of an electronic device for outputting a vibration based on a pressure on a button according to various embodiments;

FIG. 4A is a diagram illustrating an example internal structure of an example electronic device in which a button assembly is disposed according to various embodiments;

FIG. 4B is a cross-sectional view illustrating an example structure of a button assembly according to various embodiments;

FIG. 5 is a block diagram illustrating an example configuration of an electronic device according to various embodiments;

FIG. 6 is a diagram illustrating an example operation of an electronic device according to various embodiments;

FIG. 7A is a diagram illustrating an example operation of an electronic device according to various embodiments;

FIG. 7B is a diagram illustrating an example operation of an electronic device according to various embodiments;

FIG. 8 is a diagram illustrating an example operation in which a second signal is provided from a piezo actuator to a processor according to various embodiments;

FIG. 9 includes graphs illustrating a charge amount charged between a first terminal and a second terminal of a piezo actuator and a voltage output via comparison circuitry according to various embodiments;

FIG. 10A is a flowchart illustrating an example operation of an electronic device according to various embodiments;

FIG. 10B is a flowchart illustrating an example operation of an electronic device according to various embodiments;

FIG. 11 is a block diagram illustrating an example configuration of a processor according to various embodiments;

FIG. 12 is a flowchart illustrating an example operation of an auxiliary processor included in a processor according to various embodiments;

FIG. 13 is a cross-sectional view illustrating an example structure of a button assembly according to various embodiments; and

FIG. 14 is a diagram illustrating an example operation in which signals are provided from piezo actuators to a processor according to various embodiments.

### DETAILED DESCRIPTION

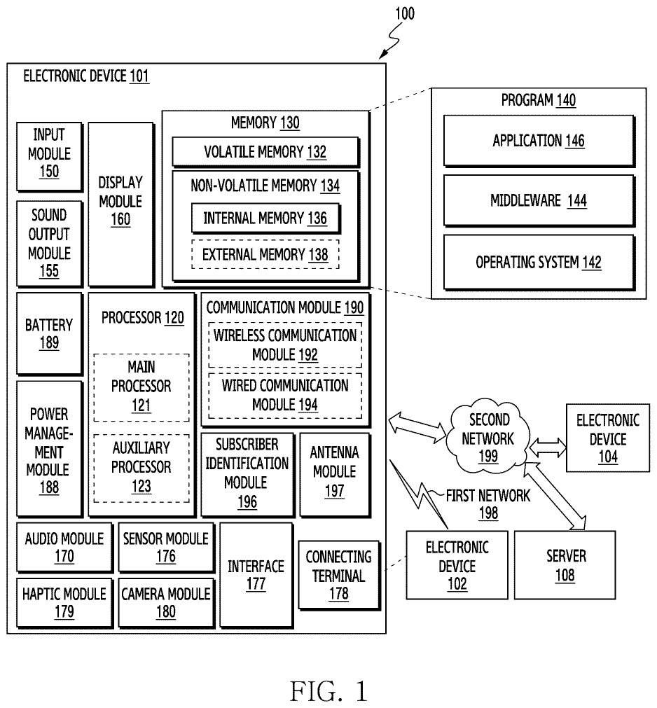

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

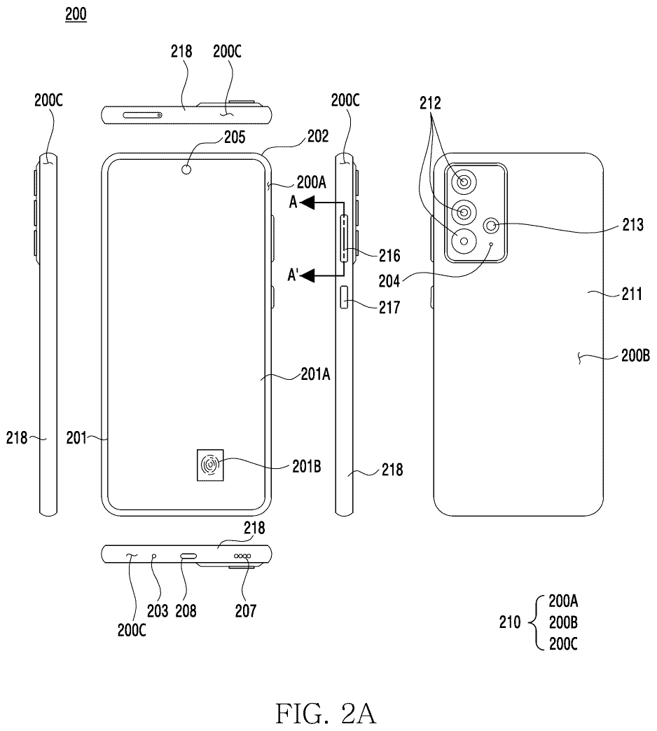

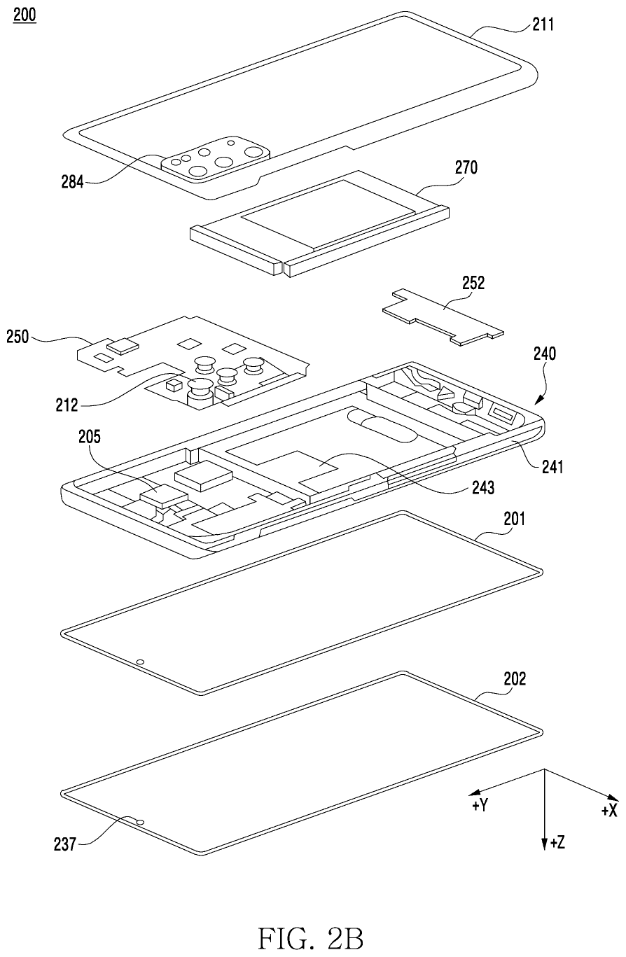

FIG. 2A is a diagram illustrating an example electronic device according to various embodiments.

Referring to FIG. 2A, an electronic device 200 according to an embodiment may include a housing 210 that at least partially forms an exterior of the electronic device 200. For example, the housing 210 may include a first surface (or a front surface) 200A, a second surface (or a rear surface) 200B, and a third surface (or a side surface) 200C surrounding a space between the first surface 200A and the second surface 200B. In an embodiment, the housing 210 may refer to a structure forming at least a portion of the first surface 200A, the second surface 200B, and/or the third surface 200C.

The electronic device 200 according to an embodiment may include a substantially transparent front plate 202. In an embodiment, the front plate 202 may form at least a portion of the first surface 200A. In an embodiment, the front plate 202 may include, for example, a glass plate or a polymer plate including various coating layers, but is not limited thereto.

The electronic device 200 according to an embodiment may include a substantially opaque rear plate 211. In an embodiment, the rear plate 211 may form at least a portion of the second surface 200B. In an embodiment, the rear plate 211 may be formed of coated or colored glass, ceramic, polymer, metal (e.g., aluminum, stainless steel, or magnesium), or a combination of at least two of the materials.

The electronic device 200 according to an embodiment may include a side bezel structure (e.g., a side member or a bracket) 218. In an embodiment, the side bezel structure 218 may form at least a portion of the third surface 200C of the electronic device 200 by being coupled with the front plate 202 and/or the rear plate 211. For example, the side bezel structure 218 may form the entire third surface 200C of the electronic device 200. In an embodiment, the side bezel structure 218 may form the third surface 200C of the electronic device 200 together with the front plate 202 and/or the rear plate 211.

In an embodiment, in case that the third surface 200C of the electronic device 200 is partially formed by the front plate 202 and/or the rear plate 211, the front plate 202 and/or the rear plate 211 may include a portion curved and extended from its periphery toward the rear plate 211 and/or the front plate 202. The extended portion of the front plate 202 and/or the rear plate 211 may be positioned at both ends of a long edge of the electronic device 200, but is not limited to the above-described example.

In an embodiment, the side bezel structure 218 may include metal and/or polymer. In an embodiment, the rear plate 211 and the side bezel structure 218 may be integrally formed and may include the same material (e.g., a metal material such as aluminum), but are not limited thereto. For example, the rear plate 211 and the side bezel structure 218 may be formed as separate configurations and/or may include different materials.

In an embodiment, the electronic device 200 may include a display 201 (e.g., the display module 160 of FIG. 1), audio modules 203, 204, and 207 (e.g., the audio module 170 of FIG. 1), a sensor module (e.g., the sensor module 176 of FIG. 1), camera modules 205, 212, and 213 (e.g., the camera module 180 of FIG. 1), a light emitting element (not illustrated), and a connector hole 208. In an embodiment, the electronic device 200 may omit at least one (e.g., the light emitting element (not illustrated)) of the components, or may additionally include another component.

In an embodiment, the display 201 may be visible via a significant portion of the front plate 202. For example, at least a portion of the display 201 may be visible via the front plate 202 forming the first surface 200A. The display 201 may be disposed on a back surface of the front plate 202.

In an embodiment, in order to expand an area in which the display 201 is visible, an outer periphery shape of the display 201 may be formed substantially the same as an outer periphery shape of the front plate 202 adjacent to the display 201. In an embodiment, a gap between an outer periphery of the display 201 and an outer periphery of the front plate 202 may be formed substantially the same.

In an embodiment, the display 201 (or the first surface 200A of the electronic device 200) may include a screen display area 201A. In an embodiment, the display 201 may provide visual information to a user via the screen display area 201A. In an illustrated embodiment, when the first surface 200A is viewed from a front, the screen display area 201A is illustrated as being positioned in the inside of the first surface 200A by being spaced apart from an outer periphery of the first surface 200A, but is not limited thereto. For example, when the first surface 200A is viewed from the front, at least a portion of a periphery of the screen display area 201A may substantially coincide with a periphery of the first surface 200A (or the front plate 202).

In an embodiment, the screen display area 201A may include a sensing area 201B configured to obtain biometric information of the user. Herein, a meaning of “the screen display area 201A includes the sensing area 201B” may be understood as at least a portion of the sensing area 201B may be overlapped with the screen display area 201A. For example, the sensing area 201B may refer to an area capable of displaying visual information by the display 201 like another area of the screen display area 201A and additionally obtaining the biometric information (e.g., fingerprint) of the user. The sensing area 201B is illustrated to be formed in the screen display area 201A, but is not limited thereto. For example, the sensing area 201B may be formed on key buttons 216 and/or 217.

In an embodiment, the display 201 may include an area in which the first camera module 205 is positioned. For example, an opening may formed in the area of the display 201, and the first camera module 205 (e.g., a punch hole camera) may be at least partially disposed in the opening to face the first surface 200A. In this case, the screen display area 201A may surround at least a portion of a periphery of the opening. In an embodiment, the first camera module 205 (e.g., an under display camera (UDC)) may be disposed under the display 201 to overlap the area of the display 201. In this case, the display 201 may provide visual information to the user via the area, and additionally, the first camera module 205 may obtain an image corresponding to a direction toward the first surface 200A via the area of the display 201.

In an embodiment, the display 201 may be coupled with or disposed adjacent to touch sensing circuitry, a pressure sensor capable of measuring an intensity (a pressure) of a touch, and/or a digitizer that detects a magnetic field type stylus pen.

In an embodiment, the audio modules 203, 204, and 207 may include microphone holes 203 and 204 and a speaker hole 207.

In an embodiment, the microphone holes 203 and 204 may include the first microphone hole 203 formed in a partial area of the third surface 200C and the second microphone hole 204 formed in a partial area of the second surface 200B. A microphone (not illustrated) for obtaining external sound may be disposed inside the microphone holes 203 and 204. The microphone may include a plurality of microphones to sense a direction of sound, but is not limited thereto.

In an embodiment, the second microphone hole 204 formed in the partial area of the second surface 200B may be disposed adjacent to the camera modules 205, 212, and 213. For example, the second microphone hole 204 may obtain sound according to an operation of the camera modules 205, 212, and 213. However, the disclosure is not limited thereto.

In an embodiment, the speaker hole 207 may include the external speaker hole 207 and a call receiver hole (not illustrated). The external speaker hole 207 may be formed in a portion of the third surface 200C of the electronic device 200. In an embodiment, the external speaker hole 207 may be integrated into the microphone hole 203, and the speaker hole 207 and the microphone hole 203 may be implemented as one hole. Although not illustrated, the call receiver hole (not illustrated) may be formed on another portion of the third surface 200C. For example, the call receiver hole may be formed on an opposite side of the external speaker hole 207 in the third surface 200C. For example, based on an illustration of FIG. 2A, the external speaker hole 207 may be formed on the third surface 200C corresponding to a lower end portion of the electronic device 200, and the call receiver hole may be formed on the third surface 200C corresponding to an upper end portion of the electronic device 200. However, the disclosure is not limited thereto, and in an embodiment, the call receiver hole may be formed at a position other than the third surface 200C. For example, the call receiver hole may be formed by a space separated between the front plate 202 (or the display 201) and the side bezel structure 218.

In an embodiment, the electronic device 200 may include at least one speaker (not illustrated) (e.g., the sound output module 155 of FIG. 1) configured to output sound to the outside of the housing 210 via the external speaker hole 207 and/or the call receiver hole (not illustrated).

In an embodiment, the sensor module (not illustrated) may generate an electrical signal or a data value corresponding to an operating state inside the electronic device 200 or an external environmental state. For example, the sensor module may include at least one of a proximity sensor, an HRM sensor, a fingerprint sensor, a gesture sensor, a gyro sensor, a barometric sensor, a magnetic sensor, an acceleration sensor, a grip sensor, a color sensor, an infrared (IR) sensor, a biometric sensor, a temperature sensor, a humidity sensor, or an illuminance sensor.

In an embodiment, the camera modules 205, 212, and 213 may include the first camera module 205 disposed to face the first surface 200A of the electronic device 200, the second camera module 212 disposed to face the second surface 200B, and the flash 213.

In an embodiment, the second camera module 212 may include a plurality of cameras (e.g., dual cameras, triple cameras, or quad cameras). However, the second camera module 212 is not necessarily limited to including the plurality of cameras, and may include one camera.

In an embodiment, the first camera module 205 and the second camera module 212 may include one or a plurality of lenses, an image sensor, and/or an image signal processor.

In an embodiment, the flash 213 may include, for example, a light emitting diode or a xenon lamp. In an embodiment, two or more lenses (an infrared camera and wide-angle and telephoto lenses) and image sensors may be disposed on one surface of the electronic device 200.

In an embodiment, the electronic device 200 may include one or more key button assemblies (e.g., the input module 150 of FIG. 1). The one or more key button assemblies may include one or more key buttons disposed in the housing 210 to form a portion of the exterior of the electronic device 200. For example, the one or more key button assemblies may include key buttons 167 and/or 168 at least partially accommodated in a frame structure 240 to form a portion of the third surface 200C of the electronic device 200.

In an embodiment, the connector hole 208 may be formed on the third surface 200C of the electronic device 200 such that a connector of an external device may be accommodated. A connecting terminal (e.g., the connecting terminal 178 of FIG. 1) electrically connected to the connector of the external device may be disposed in the connector hole 208. The electronic device 200 according to an embodiment may include an interface module (e.g., the interface 177 of FIG. 1) for processing an electrical signal transmitted and received via the connecting terminal.

According to an embodiment, the electronic device 200 may include the light emitting element (not illustrated). For example, the light emitting element (not illustrated) may be disposed on the first surface 200A of the housing 210. The light emitting element (not illustrated) may provide state information of the electronic device 200 in an optical form. In an embodiment, the light emitting device (not illustrated) may provide a light source linked to an operation of the first camera module 205. For example, the light emitting element (not illustrated) may include an LED, an IR LED, and/or a xenon lamp.

FIG. 2B is an exploded perspective view of an example electronic device according to various embodiments. Referring to FIG. 2B, the electronic device 200 according to an embodiment may include a frame structure 240 (e.g., the side bezel structure 218 of FIG. 2A), a first printed circuit board 250, a second printed circuit board 252, and a battery 270 (e.g., the battery 189 of FIG. 1).

In an embodiment, the frame structure 240 may be positioned between the display 201 and the rear plate 211. In an embodiment, the frame structure 240 may support or accommodate components included in the electronic device 200. For example, the display 201 may be disposed on a surface of the frame structure 240 facing a direction (e.g., a +Z direction). The first printed circuit board 250, the second printed circuit board 252, the battery 270, and the second camera module 212 may be disposed on another surface of the frame structure 240 facing another direction (e.g., a −Z direction) opposite to the direction. The first printed circuit board 250, the second printed circuit board 252, the battery 270, and the second camera module 212 may be disposed in a recess formed in the frame structure 240.

In an embodiment, the frame structure 240 may include a first part 241 and a second part 243. A peripheral portion of the second part 243 may be surrounded by the first part 241. The first part 241 may surround a space between the rear plate 211 and the front plate 202 (and/or the display 201). The first part 241 surrounding the space may at least partially form the side surface (e.g., the third surface 200C of FIG. 2A) of the electronic device 200, and the second part 243 positioned in the space may extend inwardly from the first part 241. The second part 243 may be positioned (e.g., the −Z direction) under the display 201. In an embodiment, the first part 241 and/or the second part 243 may be formed of metal and/or polymer.

In an embodiment, the first part 241 of the frame structure 240 forming the side surface of the electronic device 200 may be referred to as a side member, and the second part 243 of the frame structure 240 supporting various components of the electronic device 200 may be referred to as a support member.

In an embodiment, the first printed circuit board 250, the second printed circuit board 252, and the battery 270 may be coupled with the frame structure 240, respectively. For example, the first printed circuit board 250 and the second printed circuit board 252 may be fixedly disposed in the frame structure 240 via a coupling member such as a screw. For example, the battery 270 may be fixedly disposed in the frame structure 240 via an adhesive member (e.g., a double-sided tape). However, the disclosure is not limited to the above-described example.

In an embodiment, the display 201 may be disposed between the frame structure 240 and the front plate 202. For example, the front plate 202 may be disposed on a side (e.g., the +Z direction) of the display 201, and the frame structure 240 may be disposed on another side (e.g., the −Z direction).

In an embodiment, the front plate 202 may be coupled with the display 201. For example, the display 201 may be attached to the back surface of the front plate 202 via an optical adhesive member (e.g., optically clear adhesive (OCA) or optically clear resin (OCR)).

In an embodiment, the front plate 202 may be coupled with the frame structure 240. For example, the front plate 202 may include an outer periphery portion extending outside the display 201 when viewed in a z-axis direction. The outer periphery portion of the front plate 202 may be coupled to the frame structure 240 (e.g., the first part 241).

In an embodiment, a processor (e.g., the processor 120 of FIG. 1), memory (e.g., the memory 130 of FIG. 1), and/or an interface (e.g., the interface 177 of FIG. 1) may be disposed on the first printed circuit board 250 and/or the second printed circuit board 252. The processor may include, for example, one or more of a central processing unit, an application processor, a graphic processing unit, an image signal processor, a sensor hub processor, or a communication processor. The memory may include, for example, volatile memory or non-volatile memory. The interface may include, for example, a high definition multimedia interface (HDMI), a universal serial bus (USB), an SD card interface, and/or an audio interface. The interface may electrically or physically connect the electronic device 200 to an external electronic device, and may include a USB connector, an SD card/MMC connector, or an audio connector. In an embodiment, the first printed circuit board 250 and the second printed circuit board 252 may be operatively or electrically connected to each other via a connecting member (e.g., a flexible printed circuit board).

In an embodiment, the battery 270 may supply power to at least one component of the electronic device 200. For example, the battery 270 may include a rechargeable secondary battery or a fuel cell.

In an embodiment, the first camera module 205 (e.g., a front camera) may be disposed in at least a portion (e.g., the second part 243) of the frame structure 240 such that a lens may receive external light via a partial area (e.g., a camera area 237) of the front plate 202 (e.g., the front surface 200A of FIG. 2A).

In an embodiment, the second camera module 212 (e.g., a rear camera) may be disposed between the frame structure 240 and the rear plate 211. In an embodiment, the second camera module 212 may be electrically connected to the first printed circuit board 250 via a connecting member (e.g., a connector). In an embodiment, the second camera module 212 may be disposed such that a lens may receive external light via a camera area 284 of the rear plate 211 of the electronic device 200.

In an embodiment, the camera area 284 may be formed on a surface (e.g., the rear surface 200B of FIG. 2A) of the rear plate 211. In an embodiment, the camera area 284 may be formed to be at least partially transparent such that external light may be incident on the lens of the second camera module 212. In an embodiment, at least a portion of the camera area 284 may protrude from the surface of the rear plate 211 to a predetermined height. However, the disclosure is not limited thereto, and in an embodiment, the camera area 284 may form a substantially same plane as the surface of the rear plate 211.

In an embodiment, the housing 210 of the electronic device 200 may refer to a configuration or a structure forming at least a portion of the exterior of the electronic device 200. In this regard, at least a portion of the front plate 202, the frame structure 240, and/or the rear plate 211 forming the exterior of the electronic device 200 may be referred to as the housing 210 of the electronic device 200.

In the disclosure, the same reference numeral may be assigned to the same or similar configuration, and an overlapping description for a configuration having the same reference numeral as a configuration of another drawing may not be repeated. In the following description, a reference numeral of another drawing may be referenced.

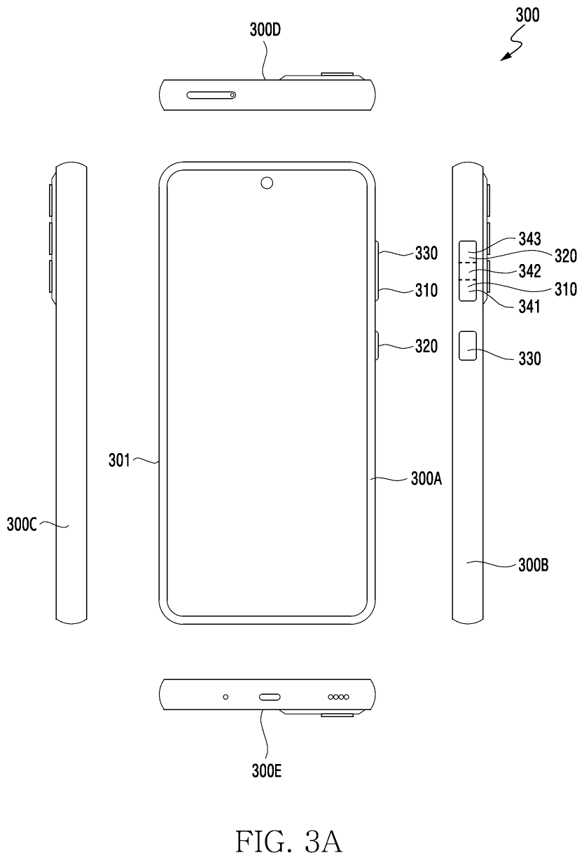

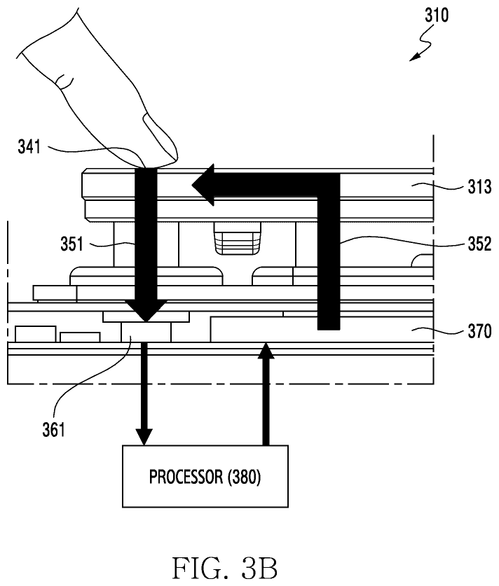

FIG. 3A is a diagram illustrating an example of buttons included in an electronic device according to various embodiments.

Referring to FIG. 3A, an electronic device 300 may correspond to the electronic device 101 of FIG. 1 or the electronic device 200 of FIGS. 2A and 2B.

According to an embodiment, the electronic device 300 may include a housing 301 defining an exterior of the electronic device 300. The electronic device 300 may include a button 310, a button 320, and a button 330. For example, each of the button 310, the button 320, and the button 330 may protrude from a portion of the housing 301, or may be defined on a portion of the housing 301. For example, the button 310 may protrude from a first portion of the housing 301 or may be defined on the first portion. The button 320 may protrude from a second portion of the housing 301 or may be defined on the second portion. The button 330 may protrude from a third portion of the housing 301 or may be defined on the third portion.

In FIG. 3A, an example in which the button 310, the button 320, and the button 330 are all disposed on a second surface 300B of the electronic device 300 is illustrated, but is not limited thereto. At least one or all of the button 310, the button 320, and the button 330 may be disposed on a third surface 300C, a fourth surface 300D, and a fifth surface 300E of the electronic device 300.

According to an embodiment, the button 310 and the button 320 may be included in one button assembly. For example, the button assembly may include one base frame 313 for the button 310 and the button 320. The base frame 313 may be exposed to the outside of the electronic device 300. For example, the base frame 313 may include an area 341, an area 342, and an area 343. The button 310 may be defined based on a first portion of the base frame 313. The button 320 may be defined based on a second portion of the base frame 313.

For example, the area 341 may correspond to the button 310. The electronic device 300 may execute a function allocated to a pressure on the button 310 based on the pressure on the button 310 (or a pressure on the area 341).

For example, the area 343 may correspond to the button 320. The electronic device 300 may execute a function allocated to a pressure on the button 320 based on the pressure on the button 320 (or a pressure on the area 343).

For example, the electronic device 300 may identify a pressure on the area 342 using the button 310 and the button 320. The electronic device 300 may execute a function (e.g., an artificial intelligence function or a voice recognition function) allocated to the pressure on the area 342 based on the pressure on the area 342.

According to an embodiment, the electronic device 300 may identify a swipe input on the base frame 313 of the button assembly. For example, the electronic device 300 may identify a swipe input following an order of the area 341, the area 342, and the area 343. The electronic device 300 may execute a function (e.g., an increase in a volume of the electronic device 300) allocated to the swipe input following the order of the area 341, the area 342, and the area 343. For example, the electronic device 300 may identify a swipe input following an order of the area 343, the area 342, and the area 341. The electronic device 300 may execute a function (e.g., a decrease in a volume of the electronic device 300) allocated to the swipe input following the order of the area 343, the area 342, and the area 341.

According to an embodiment, the button assembly including the button 310 and the button 320 may include pressure sensor and/or at least one piezo actuator. For example, the button assembly may include a pressure sensor for the button 310, a pressure sensor for the button 320, and a piezo actuator for the button 310 and the button 320. For example, the piezo actuator may be referred to as a vibration element.

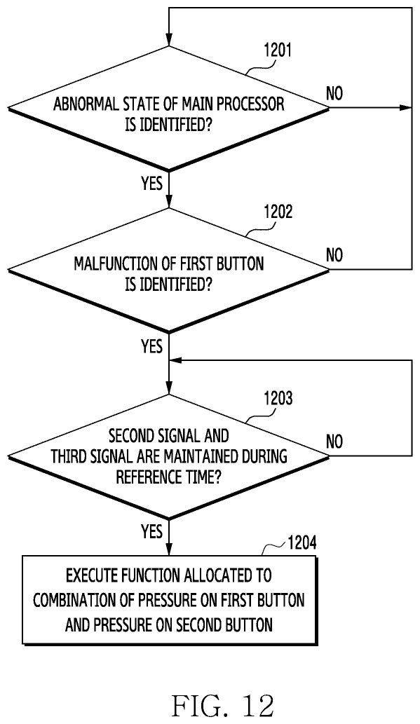

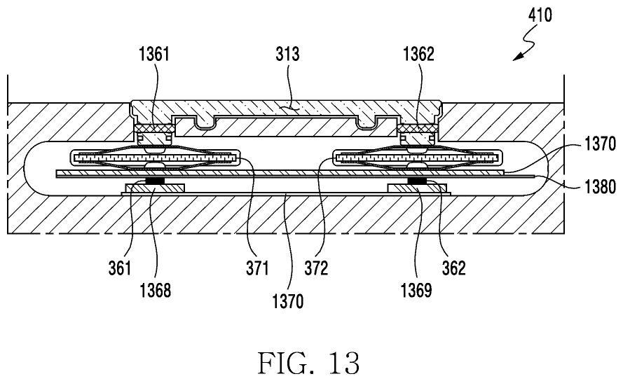

According to an embodiment, the button assembly may include the pressure sensor for the button 310, the piezo actuator for the button 310, the pressure sensor for the button 320, and a piezo actuator for the button 320. An example in which the electronic device 300 includes the button assembly including two pressure sensors and two piezo actuators will be described in greater detail below with reference to FIGS. 12 and 13.

According to an embodiment, the electronic device 300 may include the pressure sensor and the piezo actuator for the button 320. According to an embodiment, the electronic device 300 may include a switch circuit for the button 320.

According to an embodiment, the electronic device 300 may identify the pressure on the button 310 via the pressure sensor. The electronic device 300 may output a vibration via the piezo actuator based on the pressure on the button 310. The electronic device 300 may output a vibration (or a haptic feedback) via the base frame 313. According to an embodiment, the electronic device 300 may identify the pressure on the button 320 via the pressure sensor. The electronic device 300 may output a vibration (or a haptic feedback) via the piezo actuator based on the pressure on the button 320.

An example operation of the electronic device 300 to provide a vibration via the piezo actuator based on the pressure on the button 310 will be described in greater detail below with reference to FIG. 3B.

FIG. 3B is a diagram illustrating an example operation of an electronic device for outputting a vibration based on a pressure on a button according to various embodiments.

Referring to FIG. 3B, the electronic device 300 may output a vibration using a piezo actuator 370 based on the pressure on the button 310. In FIG. 3B, an example in which the vibration is output based on the pressure on the button 310 is described, but is not limited thereto. The operation described in FIG. 3B may also be applied to the button 320 and the button 330.

According to an embodiment, a user of the electronic device 300 may apply a pressure to the area 341 of the base frame 313. A pressure sensor 361 (e.g., a first pressure sensor) of the electronic device 300 may identify the pressure applied to the area 341 in a direction 351. For example, the pressure sensor 361 may be disposed under the area 341.

For example, the pressure sensor 361 may provide a processor 380 with a first signal indicating that the pressure on the button 310 has been identified. The processor 380 may identify an input on the button 310 based on the first signal. The processor 380 may drive the piezo actuator 370 based on the input on the button 310. For example, the processor 380 may drive the piezo actuator 370 by applying a specified voltage to the piezo actuator 370. According to an embodiment, the processor 380 may drive the piezo actuator 370 via piezo actuator management circuitry (not illustrated) (or a piezo actuator driver integrated circuit (IC)). The processor 380 may control power management circuitry (not illustrated) to provide a voltage to the piezo actuator 370.

According to an embodiment, the processor 380 may determine a vibration pattern based on the input on the button 310. The processor 380 may drive the piezo actuator 370 based on the vibration pattern. The piezo actuator 370 may output a vibration according to the vibration pattern. The vibration output via the piezo actuator 370 may be transmitted to the base frame 313 along a path 352.

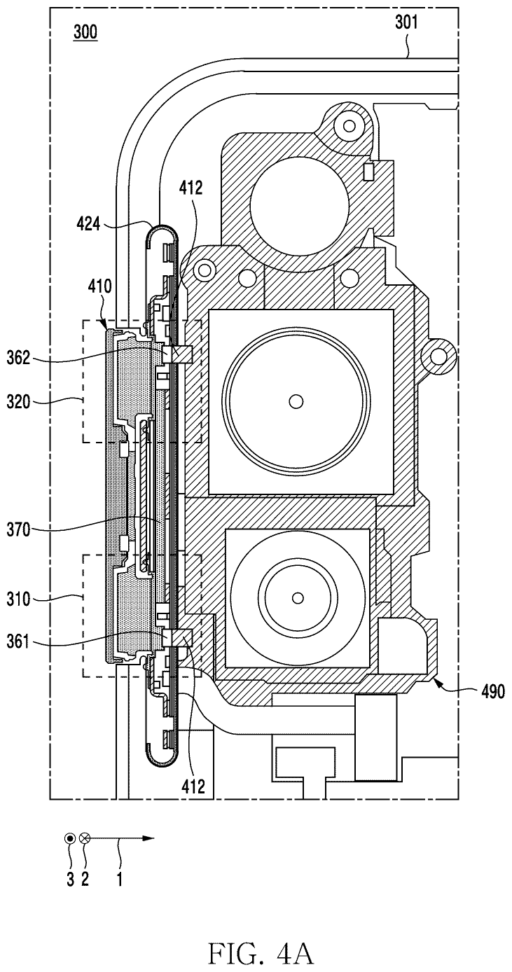

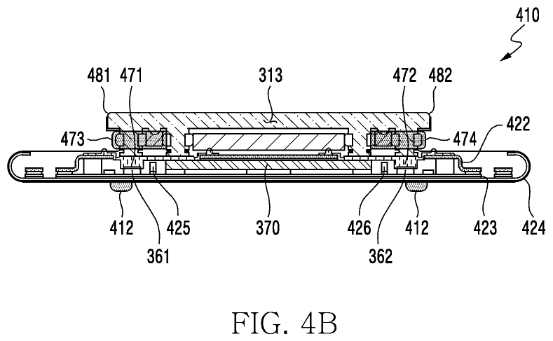

FIG. 4A is a diagram illustrating an internal structure of an example electronic device in which a button assembly is disposed according to various embodiments.

FIG. 4B is a cross-sectional view illustrating an example structure of a button assembly according to various embodiments.

Referring to FIG. 4A, FIG. 4A may indicate an internal structure of an electronic device 300 when viewing a rear surface of the electronic device 300. The electronic device 300 may include a button assembly 410. The button assembly 410 may be an example of the button assembly described above. According to an embodiment, the button assembly 410 may be disposed in a housing 301 of the electronic device 300. The button assembly 410 may include a bracket 490 disposed adjacent to the button assembly 410.

For example, the bracket 490 may be fixed to the housing 301. For example, the bracket 490 may be fixed to the housing 301 via a fastening member such as a screw. For example, the button assembly 410 may include a support structure 424 including a spacer 412. The spacer 412 may be used to connect the button assembly 410 and the bracket 490. For example, the spacer 412 may be configured to limit movement of the button assembly 410. For example, the bracket 490 may be formed of a material (as a non-limiting example, metal) having rigidity that may mechanically support a key button assembly 601.

According to an embodiment, the button assembly 410 may include a button 310 and a button 320. The button assembly 410 may include a pressure sensor 361 for the button 310. The button assembly 410 may include a pressure sensor 362 (e.g., a second pressure sensor) for the button 320. The button assembly 410 may include a piezo actuator 370 for the button 310 and the button 320.

Referring to FIG. 4B, the button assembly 410 may include a base frame 313, a first waterproof member 471, a second waterproof member 472, a first rubber 473, a second rubber 474, the pressure sensor 361, the pressure sensor 362, the spacer 412, a support plate 422, the support structure 424, a support member 425 (e.g., a first support member), and/or a support member 426 (e.g., a second support member). For example, each of the first waterproof member 471 and the second waterproof member 472 may be referred to as a rubber.

According to an embodiment, the pressure sensor 361, the pressure sensor 362, and the piezo actuator 370 may be disposed on a printed circuit board 423. The printed circuit board 423 may be disposed on the support structure 424. The support structure 424 may include the spacer 412.

According to an embodiment, the base frame 313 may be formed of metal and/or plastic. For example, a portion of the base frame 313 exposed to the outside of the electronic device 200 may be formed of metal, and a remaining portion of the base frame 313 may be formed of plastic. For example, an outer surface (e.g., an area 341, an area 342, and an area 343) of the base frame 313 may be formed of metal. The remaining portion of the base frame 313 may be formed of plastic, but is not limited thereto. For example, the entire base frame 313 may be formed of metal or plastic. For example, the base frame 313 may include a protrusion unit 481 and a protrusion unit 482 formed to protrude from a side surface of the housing 301.

According to an embodiment, the first waterproof member 471 and the first rubber 473 may be positioned between the base frame 313 and the support plate 422. For example, the first waterproof member 471 may be disposed on the support plate 422. For example, the first waterproof member 471 may be disposed on the support plate 422 to cover a hole of the support plate 422 formed for the pressure sensor 361. The first waterproof member 471 may prevent and/or reduce/block a foreign substance such as dust and/or moisture from being introduced into the hole, by sealing the hole of the support plate 422 formed for the pressure sensor 361. For example, the first rubber 473 may be disposed under the base frame 313. The first rubber 473 may be connected to the first waterproof member 471. The first rubber 473 may be disposed to alleviate an impact according to a pressure on the button 310.

According to an embodiment, a pressure on an area (e.g., the area 341) of the base frame 313 corresponding to the pressure sensor 361 may be transmitted to the pressure sensor 361 via the first waterproof member 471.

According to an embodiment, the second waterproof member 472 and the second rubber 474 may be positioned between the base frame 313 and the support plate 422. For example, the second waterproof member 472 may be disposed on the support plate 422. For example, the second waterproof member 472 may be disposed on the support plate 422 to cover a hole of the support plate 422 formed for the pressure sensor 362. The second waterproof member 472 may prevent/block a foreign substance such as dust and/or moisture from being introduced into the hole, by sealing the hole of the support plate 422 formed for the pressure sensor 362. For example, the second rubber 474 may be disposed under the base frame 313. The second rubber 474 may be connected to the second waterproof member 472. The second rubber 474 may be disposed to alleviate an impact according to a pressure on the button 320.

According to an embodiment, a pressure on an area (e.g., the area 343) of the base frame 313 corresponding to the pressure sensor 362 may be transmitted to the pressure sensor 362 via the second waterproof member 472.

According to an embodiment, the piezo actuator 370 may be disposed between the pressure sensor 361 and the pressure sensor 362. The piezo actuator 370 may be configured to output a vibration (or haptic feedback) based on a pressure on the base frame 313. For example, the pressure on the base frame 313 may be generated by a user input on the button 310 and/or the button 320. The user input on the button 310 and/or the button 320 may include a gesture input and/or a press input. According to the user input on the button 310 and/or the button 320, a vibration pattern output via the piezo actuator 370 may be changed.

For example, in response to the pressure on the area (e.g., the area 341) of the base frame 313 corresponding to the pressure sensor 361, the piezo actuator 370 may be configured to output a vibration (or haptic feedback). The output vibration may be transmitted to the base frame 313 via the first waterproof member 471.

For example, in response to the pressure on the area (e.g., the area 343) of the base frame 313 corresponding to the pressure sensor 362, the piezo actuator 370 may be configured to output a vibration (or a haptic feedback). The output vibration may be transmitted to the base frame 313 via the second waterproof member 472.

According to an embodiment, the support member 425 may be disposed to limit the pressure on the area (e.g., the area 341) of the base frame 313 applied to the pressure sensor 361. For example, the support member 425 may be disposed on the support structure 424 (or the printed circuit board 423). According to an embodiment, the support member 426 may be disposed to limit the pressure on the area (e.g., the area 343) of the base frame 313 applied to the pressure sensor 362. For example, the support member 426 may be disposed on the support structure 424 (or the printed circuit board 423).

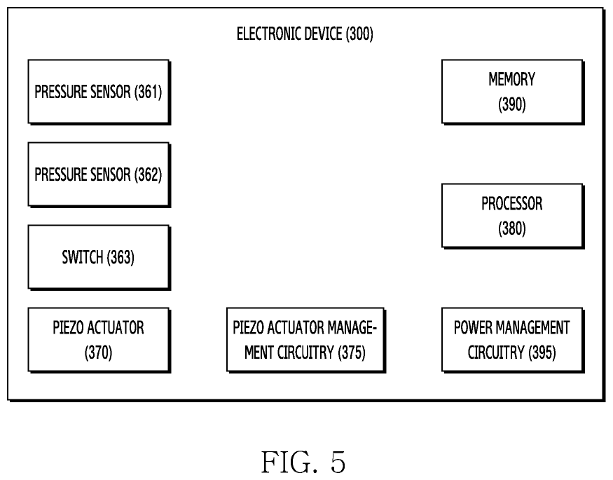

FIG. 5 is a block diagram illustrating an example configuration of an electronic device according to various embodiments.

Referring to FIG. 5, an electronic device 300 may include a pressure sensor 361, a pressure sensor 362, a switch 363, a piezo actuator 370, piezo actuator management circuitry 375, a processor (e.g., including processing circuitry) 380, memory 390, and/or power management circuitry 395. However, the disclosure is not limited thereto. For example, the pressure sensor 361, the pressure sensor 362, the switch 363, the piezo actuator 370, the piezo actuator management circuitry 375, the processor 380, the memory 390, and/or the power management circuitry 395 may be electronically and/or operably coupled with each other by a communication bus. Hereinafter, hardware components being operably coupled may refer to a direct connection or an indirect connection between the hardware components being established by wire or wirelessly, such that a second hardware component is controlled by a first hardware component among the hardware components. Although illustrated based on different blocks, the disclosure is not limited thereto, and a portion (e.g., at least a portion of the processor 380 and the memory 390) of the hardware components illustrated in FIG. 5 may be included in a single integrated circuit such as a system on a chip (SoC) or a system in package (SIP). A type and/or the number of hardware components included in the electronic device 300 is not limited as illustrated in FIG. 5. For example, the electronic device 300 may include only a portion of the hardware components illustrated in FIG. 5.

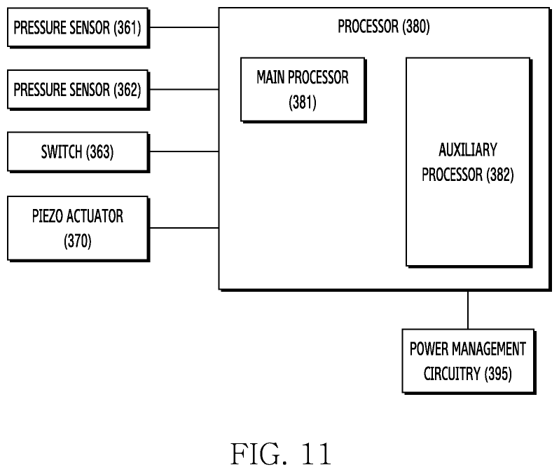

According to an embodiment, the processor 380 may include various processing circuitry and correspond to the processor 120 of FIG. 1. According to an embodiment, the processor 380 may be formed of at least one processor. For example, the processor 380 may be formed of a main processor that performs high-performance processing and an auxiliary processor that performs low-power processing. An example in which the processor 380 is formed of the main processor and the auxiliary processor will be described in greater detail below with reference to FIGS. 11 and 12.

According to an embodiment, the processor 380 may include a hardware component for processing data based on one or more instructions. The hardware component for processing the data may include, for example, an arithmetic and logic unit (ALU), a field programmable gate array (FPGA), and/or a central processing unit (CPU).

For example, the processor 380 may include an application processor, a supplementary processor (e.g., a sensor hub, a microcontroller unit (MCU)), a central processor unit (CPU), a neural processing unit (NPU), a graphic processing unit (GPU), and/or a processor for IoT (e.g., a processor integrated with a communication module).

For example, the processor 380 may include various processing circuitry and/or a plurality of processors. For example, a term “processor” used in the present disclosure, including scope of claims, may include various processing circuitry including at least one processor, and one or more of the at least one processor may be configured to perform various functions described below individually and/or collectively in a distributed manner. As used below, in case that “processor”, “at least one processor”, and “one or more processors” are described as being configured to perform various functions, these terms encompass, for example, without limitation, situations in which one processor performs a portion of cited functions and other processor(s) perform another portion of the cited functions, and also situations in which one processor may perform all of the cited functions. Additionally, the at least one processor may include a combination of processors that perform various functions listed/disclosed, for example, in a distributed manner. The at least one processor may execute program instructions to accomplish or perform various functions.

For example, the processor 380 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the electronic device 300 may include the pressure sensor 361, the pressure sensor 362, and/or the switch 363. The pressure sensor 361 may be used to identify a pressure (or a pressure input) on the button 310. The pressure sensor 362 may be used to identify a pressure (or a pressure input) on the button 320. The switch 363 may be used to identify a pressure (or a pressure input) on the button 330. According to an embodiment, the switch 363 may be configured based on a dome switch or a pressure sensor.

For example, the pressure sensors 361 and 362 may include an electric pressure sensor, a piezoelectric pressure sensor, an optical pressure sensor, and/or a capacitive pressure sensor. For example, the pressure sensors 361 and 362 may be configured to identify a pressure input based on a pressure applied to the buttons 310 and 320.

According to an embodiment, the electronic device 300 may include the piezo actuator 370. The piezo actuator 370 may be used to convert an electrical signal into a vibration. A vibration may refer to a mechanical stimulus that a user may perceive via a tactile sensation or a kinesthetic sense. The piezo actuator 370 is not limited to a device that simply generates a vibration but may refer to a device capable of transmitting a mechanical stimulus via a medium.

According to an embodiment, the piezo actuator 370 may be used to identify a pressure as well as vibration output. For example, the piezo actuator 370 may operate based on a converse piezoelectric effect. The piezo actuator 370 may also operate based on a piezoelectric effect. Therefore, in case that a pressure is applied to the piezo actuator 370, a voltage may be generated between terminals of the piezo actuator 370. The electronic device 300 (or the processor 380) may identify that the pressure is applied to the piezo actuator 370 based on a voltage difference between the terminals of the piezo actuator 370.

For example, the piezo actuator 370 may include a first terminal and a second terminal. The processor 380 may apply a voltage between the first terminal and the second terminal using the piezo actuator management circuitry 375. The processor 380 may output a vibration via the piezo actuator 370 based on applying the voltage between the first terminal and the second terminal.

For example, in case that the pressure is applied to the piezo actuator 370, the voltage difference between the first terminal and the second terminal may be within a reference voltage range. In case that the pressure is not applied to the piezo actuator 370, the voltage difference between the first terminal and the second terminal may be out of the reference voltage range. The processor 380 may identify whether the pressure has been applied to the piezo actuator 370 based on the voltage difference between the first terminal and the second terminal.

In the following description, an example embodiment for using the piezo actuator 370 for pressure identification as well as vibration output will be described.

According to an embodiment, the electronic device 300 may include the piezo actuator management circuitry 375. For example, the piezo actuator management circuitry 375 may be referred to as a piezo actuator driver integrated circuit (IC). The piezo actuator management circuitry 375 may be configured to control the piezo actuator 370 to output a vibration. The piezo actuator management circuitry 375 may be connected to the piezo actuator 370 based on a signal line for driving the piezo actuator 370. For example, the piezo actuator management circuitry 375 may drive the piezo actuator 370 based on applying the voltage between the first terminal and the second terminal of the piezo actuator 370.

According to an embodiment, the electronic device 300 may include the memory 390. The memory 390 may be used to store information or data. For example, the memory 390 may correspond to the memory 130 of FIG. 1. For example, the memory 390 may be a volatile memory unit or units. For example, the memory 390 may be a non-volatile memory unit or units. For example, the memory 390 may be another form of a computer readable medium, such as a magnetic or optical disk. For example, the memory 390 may store data obtained based on an operation (e.g., an algorithm execution operation) performed by the processor 380. According to an embodiment, the memory 390 may be configured in an integrated form with the processor 380.

According to an embodiment, in the memory 390, one or more instructions (or commands) indicating a calculation and/or an operation to be performed on data by the processor 380 of the electronic device 300 may be stored. A set of one or more instructions may be referred to as a program, firmware, an operating system, a process, a routine, a sub-routine and/or an application. Hereinafter, an application being installed in the electronic device (e.g., the electronic device 300) may refer to one or more instructions provided in a form of the application being stored in the memory, and that the one or more applications are stored in a format (e.g., a file having an extension specified by an operating system of the electronic device 300) executable by the processor of the electronic device. According to an embodiment, the electronic device 300 may perform operations of the electronic device 300 described below, by executing the one or more instructions stored in the memory. For example, the one or more instructions, when executed by the processor 380, may cause the electronic device 300 to perform at least a portion of the operations of the electronic device 300 described below.

According to an embodiment, the electronic device 300 may include the power management circuitry 395. For example, the power management circuitry 395 may correspond to the power management module 188 of FIG. 1. For example, the power management circuitry 395 may be referred to as a power management integrated circuit (PMIC). The power management circuitry 395 may be used to obtain charging state information (e.g., life, overvoltage, undervoltage, overcurrent, overcharge, over discharge, overheating, short circuit, or swelling) associated with charging of a battery of the electronic device 300. For example, the power management circuitry 395 may be used to an operation of the piezo actuator 370. The power management circuitry 395 may provide a voltage (or power) for driving the piezo actuator 370.

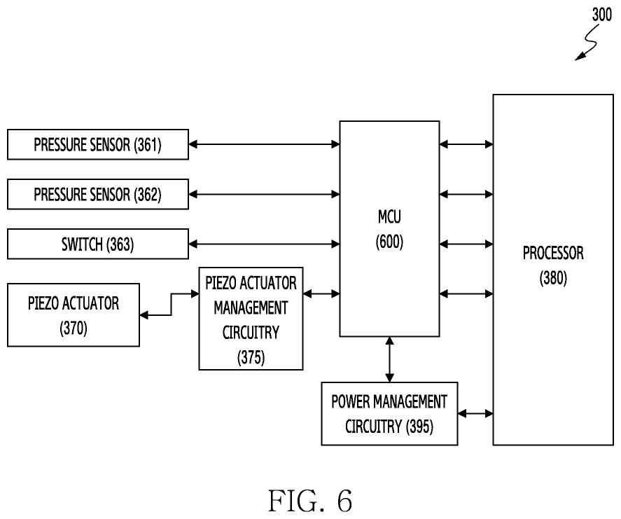

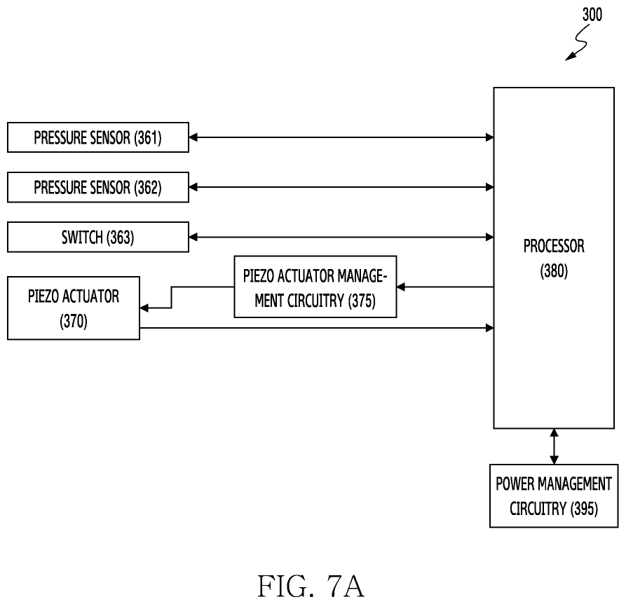

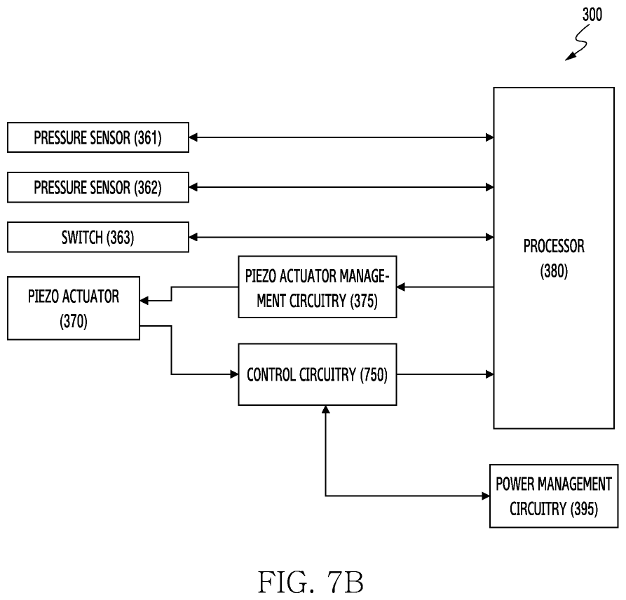

In FIGS. 6, 7A, and 7B below, an example of signals provided inside the electronic device will be described in greater detail.

FIG. 6 is a diagram illustrating an example operation of an electronic device according to various embodiments.

Referring to FIG. 6, an electronic device 300 may include the components illustrated in FIG. 5. For example, the electronic device 300 may further include a micro controller unit (MCU) 600. For example, the MCU (e.g., including various circuitry) 600 may be used to manage a pressure sensor 361, a pressure sensor 362, a switch 363, and/or a piezo actuator 370.

For example, the pressure sensor 361 may provide the MCU 600 with a signal indicating that a pressure on a button 310 has been identified. The MCU 600 may provide a processor 380 with the signal indicating that the pressure on the button 310 has been identified. The processor 380 may execute a function allocated to the pressure on the button 310 based on the signal received from the MCU 600.

For example, the pressure sensor 362 may provide the MCU 600 with a signal indicating that a pressure on a button 320 has been identified. The MCU 600 may provide the processor 380 with the signal indicating that the pressure on the button 320 has been identified. The processor 380 may execute a function allocated to the pressure on the button 320 based on the signal received from the MCU 600.

For example, the switch 363 may provide the MCU 600 with a signal indicating that an input on a button 330 has been identified. The MCU 600 may provide the processor 380 with the signal indicating that the input on the button 330 has been identified. The processor 380 may execute a function allocated to the input on the button 330 based on the signal received from the MCU 600.

According to an embodiment, the processor 380 may output a vibration via the piezo actuator 370 based on identifying the pressure on the button 310 and/or the button 320. The processor 380 may provide (or transmit), to the MCU 600, a signal for indicating to output a vibration via the piezo actuator 370. The MCU 600 may provide (or transmit), to piezo actuator management circuitry 375, the signal for indicating to output the vibration via the piezo actuator 370. The piezo actuator management circuitry 375 may apply a voltage for outputting the vibration to the piezo actuator 370 based on the signal. For example, power for the voltage to output the vibration may be provided from the power management circuitry 375.

According to an embodiment, based on the pressure on the button 310 and/or the button 320, a voltage difference between a first terminal and a second terminal of the piezo actuator 370 may be changed within a reference voltage range. The piezo actuator management circuitry 375 may identify that the voltage difference between the first terminal and the second terminal has been changed within the reference voltage range. The piezo actuator management circuitry 375 may provide the MCU 600 with a signal indicating that the voltage difference between the first terminal and the second terminal is changed within the reference voltage range. According to an embodiment, the signal may also indicate that the pressure has been applied to the button 310 and/or the button 320. The MCU 600 may provide the processor 380 with the signal indicating that the voltage difference between the first terminal and the second terminal is changed within the reference voltage range. The processor 380 may identify that the pressure is applied to the button 310 and/or the button 320 based on the obtained signal. The processor 380 may perform the function allocated to the pressure on the button 310 and/or the button 320. For example, in case that the function allocated to the pressure on the button 310 and/or the button 320 is associated with the power management circuitry 395, the processor 380 may provide the power management circuitry 395 with a control signal to perform the function.

The electronic device 300 illustrated in FIG. 6 may include the MCU 600 for controlling the pressure sensor 361, the pressure sensor 362, the switch 363, and/or the piezo actuator 370. However, in case that a malfunction of the pressure sensor 361, the pressure sensor 362, the switch 363, and/or the MCU 600 occurs, the processor 380 may not identify whether a pressure (or an input) is applied to the button 310, the button 320, and/or the button 330.

For example, in case that the pressure on the button 310 and the button 320 is maintained during reference time, a reset of the electronic device 300 may be performed. As an example, in case that a malfunction of the pressure sensor 361 (or the pressure sensor 362) and/or the MCU 600 occurs, the reset of the electronic device 300 may not be performed. To prevent and/or reduce a malfunction of the MCU 600, the electronic device 300 may not include the MCU 600. In addition, since the piezo actuator 370 may identify the pressure on the button 310, the processor 380 may identify whether the pressure has occurred on the button 310 via the piezo actuator 370, in case that a malfunction of the pressure sensor 361 for the button 310 occurs. Therefore, in FIGS. 7A and 7B, an example for identifying whether the pressure has occurred on the button 310 using the piezo actuator 370 by the electronic device 300 not including the MCU 600 will be described in greater detail.

FIG. 7A is a diagram illustrating an example operation of an electronic device according to various embodiments.

FIG. 7B is a diagram illustrating an example operation of an electronic device according to various embodiments.

Referring to FIGS. 7A and 7B, a pressure sensor 361 may be connected (indirectly or directly connected) to a processor 380. A pressure sensor 362 may be connected (indirectly or directly connected) to the processor 380. A switch 363 may be connected (indirectly or directly connected) to the processor 380. For example, each of the pressure sensor 361, the pressure sensor 362, and the switch 363 may be connected via a general-purpose input/output (GPIO) of the processor 380.

For example, the processor 380 may identify a malfunction of the pressure sensor 361 (or the pressure sensor 362 or the switch 363) based on identifying that a signal is not received from the pressure sensor 361 (or the pressure sensor 362 or the switch 363). As an example, the processor 380 may identify the malfunction of the pressure sensor 361 (or the pressure sensor 362 or the switch 363) based on identifying that an identifier (ID) register value is not output from the pressure sensor 361. As an example, the processor 380 may identify the malfunction of the pressure sensor 361 (or the pressure sensor 362 or the switch 363) based on identifying that inter-integrated circuit (I2C) communication with an analogue frontend (AFE) corresponding to the pressure sensor 361 (or the pressure sensor 362 or the switch 363) is not performed.

According to an embodiment, the pressure sensor 361 may be configured to provide a first signal to the processor 380 based on a pressure on a button 310. For example, the first signal may indicate the pressure on the button 310. A piezo actuator 370 may be configured to transmit a second signal to the processor 380 based on a pressure on the button 310 and/or a button 320. For example, the second signal may indicate the pressure on the button 310 and/or the button 320. The switch 363 may be configured to provide a third signal to the processor 380 based on an input on the button 330. For example, the third signal may indicate the input on the button 330. The pressure sensor 362 may be configured to provide a fourth signal to the processor 380 based on a pressure on the button 320. For example, the fourth signal may indicate the pressure on the button 320.

In case that an electronic device 300 does not include an MCU (e.g., the MCU 600 of FIG. 6), a malfunction of the pressure sensors 361 and 362 or the switch 363 according to a malfunction of the MCU may be prevented/reduced. For example, the processor 380 may perform at least a portion or all of the functions of the MCU 600 of FIG. 6. Although not illustrated, the processor 380 may include an auxiliary processor (e.g., an auxiliary processor 382 of FIG. 11) for performing the function of the MCU 600 of FIG. 6.

Referring to FIG. 7A, the piezo actuator 370 may be connected to the processor 380 via piezo actuator management circuitry 375. For example, in order to output a vibration via the piezo actuator 370, the processor 380 may be connected to the piezo actuator 370 via the piezo actuator management circuitry 375. The piezo actuator 370 may be connected to the processor 380 to provide (or transmit or output) the processor 380 with the second signal indicating that the pressure on the button 310 and/or the button 320 is identified.

For example, for output of a vibration, the piezo actuator 370 may be connected to the processor 380 via the piezo actuator management circuitry 375. For identification of a pressure, the piezo actuator 370 may be connected to the processor 380. For identification of a pressure, the piezo actuator 370 may be connected to the processor 380 without passing through the piezo actuator management circuitry 375.

According to an embodiment, the processor 380 may detect a malfunction associated with the button 310 based on receiving the second signal from the piezo actuator 370 while the first signal is not provided from the pressure sensor 361. The processor 380 may execute a function allocated to a combination of the pressure on the button 310 and a pressure on the button 330 in response to the second signal and the third signal being maintained during reference time. The function allocated to the combination of the pressure on the button 310 and the pressure on the button 330 may be associated with a reset of the electronic device 300. For example, the processor 380 may perform the reset of the electronic device 300 based on the pressure on the button 310 and the button 330 being maintained during the reference time. Based on detecting the malfunction associated with the button 310, the processor 380 may execute the function allocated to the combination of the pressure on the button 310 and the pressure on the button 330 in response to the second signal and the third signal being maintained during the reference time.

For example, the processor 380 may execute the function allocated to the combination of the pressure on the button 310 and the pressure on the button 330 using power management circuitry 395. The processor 380 may control the power management circuitry 395 to execute the function.

Referring to FIG. 7B, the piezo actuator 370 may be connected to the processor 380 via the piezo actuator management circuitry 375. The piezo actuator 370 may be connected to the processor 380 via control circuitry 750.

For example, in order to output a vibration via the piezo actuator 370, the processor 380 may be connected to the piezo actuator 370 via the piezo actuator management circuitry 375. The piezo actuator 370 may be connected to the processor 380 via the control circuitry 750 to provide (or transmit or output) the processor 380 with the second signal indicating that the pressure on the button 310 and/or the button 320 is identified.

According to an embodiment, the control circuitry 750 may detect the malfunction associated with the button 310 based on receiving the second signal from the piezo actuator 370 while the first signal is not provided from the pressure sensor 361 to the processor 380. Although not illustrated, the third signal may be provided from the switch 363 to the power management circuitry 395.

For example, the control circuitry 750 may identify that the second signal provided from the piezo actuator 370 is maintained during the reference time (e.g., 7 seconds) based on detecting the malfunction associated with the button 310. The control circuitry 750 may provide the power management circuitry 395 with a signal indicating that the second signal has been maintained during the reference time.

The power management circuitry 395 may identify that the third signal provided from the switch 363 is maintained during the reference time. The power management circuitry 395 may perform the reset of the electronic device 300 in response to receiving the signal indicating that the second signal has been maintained during the reference time.

For example, the control circuitry 750 may detect the malfunction for the button 310 and provide the power management circuitry 395 with the signal indicating that the second signal has been maintained during the reference time. Therefore, even in case that a malfunction (or a non-operation) of the processor 380 of the electronic device 300 occurs, the reset of the electronic device 300 may be performed.

According to an embodiment, in a state in which the processor 380 is operating normally, the processor 380 may receive the first signal from the pressure sensor 361 based on the pressure on the button 310. The processor 380 may provide the control circuitry 750 with the first signal. The control circuitry 750 may identify that the first signal provided from the processor 380 is maintained during the reference time (e.g., 7 seconds). The control circuitry 750 may provide the power management circuitry 395 with a signal indicating that the first signal has been maintained during the reference time. The power management circuitry 395 may identify that the third signal provided from the switch 363 is maintained during the reference time. The power management circuitry 395 may perform the reset of the electronic device 300 in response to receiving the signal indicating that the first signal has been maintained during the reference time.

According to an embodiment, the control circuitry 750 may receive the first signal from the processor 380. The control circuitry 750 may receive the second signal from the piezo actuator 370. The control circuitry 750 may identify that at least one of the first signal and the second signal is maintained during the reference time. The control circuitry 750 may provide the power management circuitry 395 with a signal indicating that at least one of the first signal and the second signal is maintained during the reference time.

The power management circuitry 395 may identify that the third signal provided from the switch 363 is maintained during the reference time. The power management circuitry 395 may perform the reset of the electronic device 300 in response to receiving a signal indicating that at least one of the first signal and the second signal has been maintained during the reference time.

Hereinafter, for convenience of explanation, an operation in which the second signal is provided from the piezo actuator 370 to the processor 380 in the electronic device 300 illustrated in FIG. 7A will be described in greater detail. An example described below is not limited to the electronic device 300 illustrated in FIG. 7A, and may also be applied to the electronic device 300 illustrated in FIG. 6 or 7B.

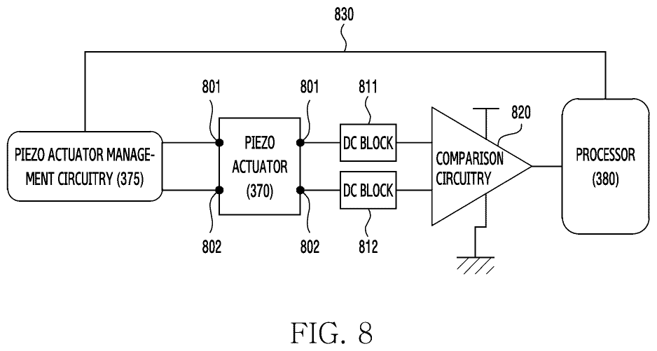

FIG. 8 is a diagram illustrating an example operation in which a second signal is provided from a piezo actuator to a processor according to various embodiments.

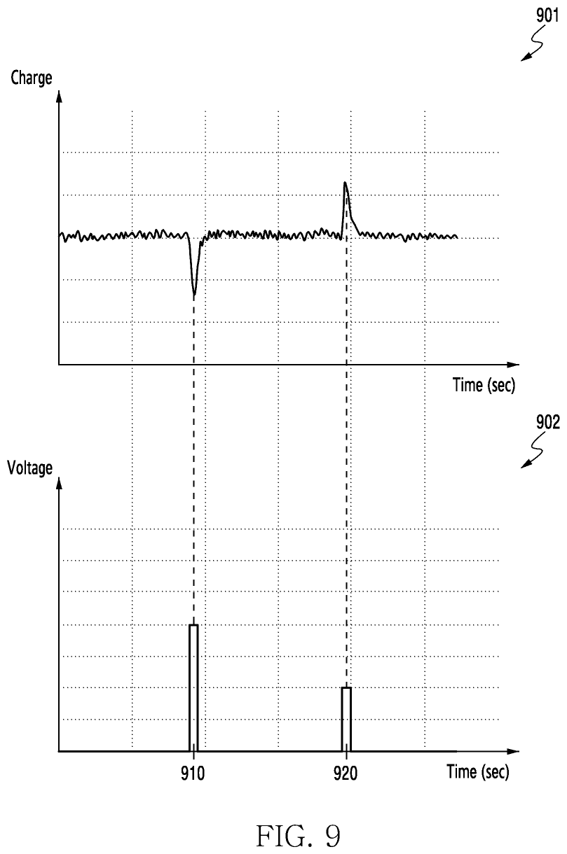

FIG. 9 includes graphs illustrating an amount of charge charged between a first terminal and a second terminal of a piezo actuator and a voltage output via comparison circuitry according to various embodiments.

Referring to FIG. 8, a piezo actuator 370 may be connected to a processor 380. For example, in order to output a vibration via the piezo actuator 370, the processor 380 may be connected to the piezo actuator 370 via piezo actuator management circuitry 375. The processor 380 may be connected to the piezo actuator management circuitry 375 via a path 830. The piezo actuator management circuitry 375 may be connected to the piezo actuator 370.

For example, the piezo actuator 370 may be connected to the processor 380 via DC blocks 811 and 812 and comparison circuitry 820 to provide (or transmit or output) the second signal indicating that a pressure on a button 310 and/or a button 320 is identified.

According to an embodiment, the piezo actuator 370 may include a first terminal 801 and a second terminal 802. For example, the first terminal 801 may be connected to the DC block 811. The first terminal 801 may be connected to the piezo actuator management circuitry 375. For example, the second terminal 802 may be connected to the DC block 812. The second terminal 802 may be connected to the piezo actuator management circuitry 375. According to an embodiment, the piezo actuator 370 may be connected to the DC block 811 and the piezo actuator management circuitry 375 via different terminals. According to an embodiment, the piezo actuator 370 may be connected to the DC block 812 and the piezo actuator management circuitry 375 via different terminals.

According to an embodiment, the processor 380 may apply a voltage for outputting a vibration to the piezo actuator 370 via the first terminal 801 and the second terminal 802. Based on the applied voltage, the piezo actuator 370 may output the vibration.

According to an embodiment, a voltage difference between the first terminal 801 and the second terminal 802 may be changed based on the pressure on the button 310 and/or the button 320. For example, since the piezo actuator 370 is a piezoelectric element, the voltage difference between the first terminal 801 and the second terminal 802 may be changed based on the pressure on the button 310 and/or the button 320.

For example, the DC block 811 may provide the comparison circuitry 820 with a direct current (DC) voltage of the first terminal 801. The DC block 812 may provide the comparison circuitry 820 with a DC voltage of the second terminal 802. The comparison circuitry 820 may identify a voltage difference between the DC voltage of the first terminal 801 and the DC voltage of the second terminal 802. For example, the comparison circuitry 820 may be configured to output the second signal based on the voltage difference between the first terminal 801 and the second terminal 802. As an example, in case that the voltage difference between the first terminal 801 and the second terminal 802 is within a reference voltage range, the comparison circuitry 820 may output the second signal. In case that the voltage difference between the first terminal 801 and the second terminal 802 is out of a reference voltage, the comparison circuitry 820 may refrain from outputting the second signal.

For example, based on the pressure on the button 310 and/or the button 320, the voltage difference between the first terminal 801 and the second terminal 802 may be changed within the reference voltage range. Therefore, the comparison circuitry 820 may output the second signal based on the pressure on the button 310 and/or the button 320. The second signal may be provided to the processor 380.

According to an embodiment, since the piezo actuator 370 is connected to the processor 380 via the comparison circuitry 820, the piezo actuator 370 may provide the second signal to the processor 380, regardless of whether the piezo actuator management circuitry 375 is operating. According to an embodiment, magnitude of a voltage applied to the piezo actuator 370 may be greater than the voltage difference changed based on the pressure on the button 310 and/or the button 320. Therefore, the comparison circuitry 820 may identify whether the changed voltage difference is within the reference voltage range based on the pressure on the button 310 and/or the button 320 while a voltage for outputting a vibration is applied to the first terminal 801 and the second terminal 802.

Referring to FIG. 9, a graph 901 indicates an amount of charge charged between the first terminal 801 and the second terminal 802 over time. The graph 901 may indicate the voltage difference between the first terminal 801 and the second terminal 802. A graph 902 indicates magnitude of a voltage output via the comparison circuitry 820 over time. For example, at a time point 910 and a time point 920, a pressure may be applied to the button 310.

Based on the pressure applied to the button 310 at the time points 910 and 920, the amount of charge charged between the first terminal 801 and the second terminal 802 of the piezo actuator 370 may be changed. The comparison circuitry 820 may output the second signal at the time points 910 and 920 based on identifying that the voltage difference between the first terminal 801 and the second terminal 802 is within the reference voltage range.

According to an embodiment, the processor 380 may identify that the pressure is applied to the button 310 (or the button 320) based on identifying that the second signal is maintained during reference time.

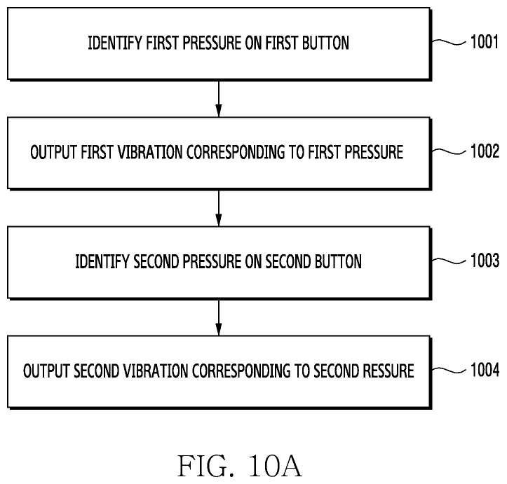

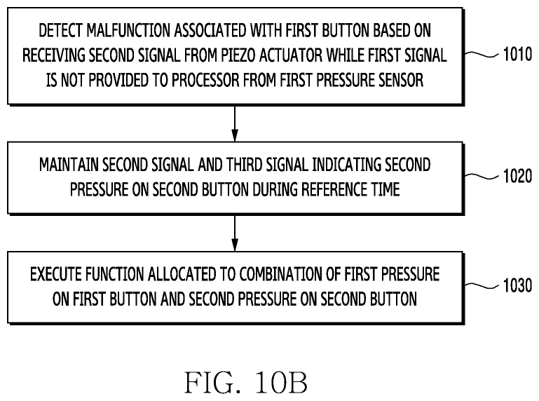

FIG. 10A is a flowchart illustrating an example operation of an electronic device according to various embodiments. In the following example, each of operations may be performed sequentially, but is not necessarily performed sequentially. For example, an order of each of the operations may be changed, and at least two operations may be performed in parallel.

Referring to FIG. 10A, an electronic device 300 may include a housing 301. The electronic device 300 may include a first button (e.g., a button 310), a second button (e.g., a button 320), and a third button (e.g., a button 330) disposed on a side surface of the housing 301. The electronic device 300 may include a first pressure sensor (e.g., a pressure sensor 361) for sensing a first pressure on the first button. The electronic device 300 may include a second pressure sensor (e.g., a pressure sensor 362) for sensing a second pressure on the second button. The electronic device 300 may include a switch circuit (e.g., a switch 363) for sensing an input on the third button.

In operation 1001, the processor 380 of the electronic device 300 may identify a first pressure on a first button (e.g., button 310). The processor 380 may identify the first pressure using a first pressure sensor (e.g., pressure sensor 361) for sensing (or identifying) the first pressure on the first button. The first pressure sensor may be located under the first button.

In operation 1002, the processor 380 may output a first vibration corresponding to the first pressure. For example, the processor 380 may output the first vibration corresponding to the first pressure through a vibration element based on identifying the first pressure. The vibration element may include a piezo actuator. However, the disclosure is not limited thereto. For example, the processor 380 may provide a vibration toward the first button through the vibration element. The processor 380 may provide a vibration toward the first button to allow the user to recognize that an input has been performed on the first button.

In operation 1003, the processor 380 may identify a second pressure on the second button (e.g., button 320). The processor 380 may identify the second pressure using a second pressure sensor (e.g., pressure sensor 362) to sense (or identify) the second pressure on the second button. The second pressure sensor may be positioned below the second button.

In operation 1004, the processor 380 may output a second vibration corresponding to the second pressure. For example, the processor 380 may output the second vibration corresponding to the second pressure through a vibration element based on identifying the second pressure. The vibration element may include a piezo actuator, but is not limited thereto. For example, the processor 380 may provide a vibration toward the second button through the vibration element. The processor 380 may provide a vibration toward the second button so that the user recognizes that an input has been performed on the second button.

According to an embodiment, the vibration element may be configured to identify at least one of the first pressure and the second pressure. For example, the vibration element may include a first terminal and a second terminal. Depending on the pressure on the first button (or the second button), a voltage difference between the first terminal and the second terminal may change. The processor 380 may identify a third pressure on the first button (or the second button) based on the voltage difference between the first terminal and the second terminal.

According to an embodiment, the processor 380 may identify a third pressure on the first button through the vibration element while the first pressure on the first button is not identified using the first pressure sensor. For example, the first pressure may be a pressure on the first button identified using the first pressure sensor. The third pressure may be a pressure on the first button identified using the vibration element.

The processor 380 may not identify the first pressure on the first button using the first pressure sensor. The processor 380 may identify the third pressure on the first button using the vibration element. The processor 380 may not identify the pressure on the first button (e.g., the first pressure) using the pressure sensor, and may identify the pressure on the first button (e.g., the third pressure) using the vibration element. Accordingly, if the first pressure on the first button is not identified using the first pressure sensor, and the third pressure on the first button is identified using the vibration element, the processor 380 may identify a malfunction of the first button.

In an embodiment, the processor 380 may identify a fourth pressure on the second button via the vibration element while the second pressure on the second button is not identified using the second pressure sensor. For example, the second pressure may be a pressure on the second button identified using the second pressure sensor. The fourth pressure may be a pressure on the second button identified using the vibration element.

The processor 380 may not identify the second pressure on the second button using the second pressure sensor. The processor 380 may identify the fourth pressure on the second button using the vibration element. The processor 380 may not identify the pressure on the second button (e.g., the second pressure) via the pressure sensor, and may identify the pressure on the second button (e.g., the fourth pressure) via the vibration element. Therefore, if the second pressure is not identified for the second button using the second pressure sensor, and the fourth pressure for the second button is identified through the vibration element, the processor 380 may identify a malfunction for the second button.

According to an embodiment, the processor 380 may display a user interface indicating the identified malfunction through a display of the electronic device based on identifying a malfunction for at least one of the first button and/or the second button.

According to an embodiment, the processor 380 may identify a third pressure for the first button using the vibration element while identifying a malfunction for the first button, and may identify an input for the third button using the switch circuit. The processor 380 may identify that the third pressure and the input for the third button are maintained for a reference time. The processor 380 may reset the electronic device 300 in response to identifying that the input to the third pressure and third button is maintained for a reference period of time.

FIG. 10B is a flowchart illustrating an example operation of an electronic device according to various embodiments. In the following example, each of operations may be performed sequentially, but is not necessarily performed sequentially. For example, an order of each of the operations may be changed, and at least two operations may be performed in parallel.

Referring to FIG. 10B, an electronic device 300 may include a housing 301. The electronic device 300 may include a first button (e.g., a button 310), a second button (e.g., a button 320), and a third button (e.g., a button 330) disposed on a side surface of the housing 301. The electronic device 300 may include a first pressure sensor (e.g., a pressure sensor 361) for sensing a first pressure on the first button. The electronic device 300 may include a second pressure sensor (e.g., a pressure sensor 362) for sensing a second pressure on the second button. The electronic device 300 may include a switch circuit (e.g., a switch 363) for sensing an input on the third button.

In operation 1010, a processor 380 of the electronic device 300 may detect a malfunction associated with the first button (e.g., the button 310) based on receiving a second signal from a piezo actuator 370 while a first signal is not provided to the processor 380 from the first pressure sensor (e.g., the pressure sensor 361).

According to an embodiment, a pressure sensor may provide (or transmit or output) the first signal to the processor 380 based on the first pressure on the first button (e.g., the button 310). The processor 380 may identify that the first pressure is applied to the first button based on the first signal. The piezo actuator 370 may provide (or transmit or output) a second signal to the processor 380 based on the first pressure on the first button (e.g., the button 310).

According to an embodiment, the piezo actuator 370 may include a first terminal (e.g., the first terminal 801 of FIG. 8) and a second terminal (e.g., the second terminal 802 of FIG. 8). The electronic device 300 may include comparison circuitry (e.g., the comparison circuitry 820 of FIG. 8) configured to output the second signal based on a voltage difference between the first terminal and the second terminal. The piezo actuator 370 may be connected to the processor 380 via the comparison circuitry 820. For example, the comparison circuitry may be configured to output the second signal in case that the voltage difference between the first terminal and the second terminal is within a reference voltage range. The comparison circuitry may be configured to refrain from outputting the second signal in case that the voltage difference between the first terminal and the second terminal is out of a reference voltage.

According to an embodiment, the processor 380 may receive the second signal from the piezo actuator 370 while the first signal is not provided to the processor 380. Since both the first signal and the second signal are provided by a pressure by the first button, the processor 380 may detect the malfunction associated with the first button based on receiving the second signal from the piezo actuator 370 while the first signal is not provided to the processor 380.

According to an embodiment, the processor 380 may output a vibration via the piezo actuator 370 based on the pressure on the first button. The processor 380 may apply a voltage for outputting the vibration to the piezo actuator 370 via the first terminal and the second terminal. According to an embodiment, the processor 380 may refrain from applying the voltage for outputting the vibration via the first terminal and the second terminal while the first signal is not provided to the processor 380.

In operation 1020, the processor 380 may identify that the second signal and a third signal indicating a pressure on the third button are maintained during reference time. The processor 380 may identify the third signal based on the pressure on the third button (e.g., the button 330). The processor 380 may identify that the second signal and the third signal are maintained during the reference time.

For example, the processor 380 may execute a function allocated to the first pressure on the first button and the input on the third button based on identifying that the first pressure on the first button and the input on the third button are maintained during the reference time. As an example, the processor 380 may perform a reset of the electronic device 300 based on identifying that the pressure on the first button and the input on the third button are maintained during the reference time. The processor 380 may perform the reset of the electronic device 300 based on pressing the first button and the third button together during specified time.

For example, based on the first signal being provided to the processor 380, the processor 380 may execute the function in response to the first signal and the third signal being maintained during the reference time.

As an example, according to the malfunction for the first button, the first signal indicating the pressure on the first button may not be provided from the pressure sensor. As in the operation 1010, the processor 380 may detect the malfunction associated with the first button based on receiving the second signal while the first signal is not provided. The processor 380 may detect the malfunction associated with the first button and identify whether the second signal is maintained during the reference time.

In operation 1030, the processor 380 may execute a function allocated to a combination of the pressure on the first button and the input on the third button. For example, the processor 380 may execute the function allocated to the combination of the pressure on the first button and the input on the third button in response to the second signal and the third signal being maintained during the reference time. For example, the function allocated to the combination of the pressure on the first button and the input on the third button may be associated with the reset of the electronic device 300. The processor 380 may provide a control signal to power management circuitry 395 to execute the function allocated to the combination of the pressure on the first button and the input on the third button. The processor 380 may perform the reset of the electronic device 300 using the power management circuitry 395.

FIG. 11 is a block diagram illustrating an example configuration of a processor according to various embodiments.

FIG. 12 is a flowchart illustrating an example operation of an auxiliary processor included in a processor according to various embodiments. In the following example, each of operations may be performed sequentially, but is not necessarily performed sequentially. For example, an order of each of the operations may be changed, and at least two operations may be performed in parallel.

Referring to FIG. 11, a processor (e.g., including processing circuitry) 380 may include a main processor (e.g., including processing circuitry) 381 and an auxiliary processor (e.g., including processing circuitry) 382. For example, in case that the main processor 381 operates normally, the main processor 381 may identify a pressure on a button 310 based on identifying a first signal provided from a pressure sensor 361. The main processor 381 may output a vibration via a piezo actuator 370 based on the pressure on the button 310. The output vibration may be transmitted to the button 310. The processor 380 may provide a haptic effect based on the vibration transmitted to the button 310.

According to an embodiment, the main processor 381 may be configured for an operating system (OS). The auxiliary processor 382 may be configured to compensate for a malfunction of the main processor 381. According to an embodiment, the auxiliary processor 382 may be configured for management of at least one pressure sensor (e.g., a pressure sensor 361 and a pressure sensor 362), a switch 363, and/or the piezo actuator 370. The auxiliary processor 382 may be referred to as a sensor hub.

Although not illustrated, for example, the main processor 381 may perform an operation based on one or more instructions (or commands) indicating a calculation and/or an operation to be performed. According to an embodiment, the one or more instructions may be stored in memory 390 of an electronic device 300. For example, the main processor 381 may include an application layer, a framework layer, a hardware abstraction layer, and/or a Linux kernel. For example, the auxiliary processor 382 may include a layer for management of at least one pressure sensor (e.g., the pressure sensor 361, the switch 363, and the pressure sensor 362), and/or the piezo actuator 370 and a layer for a neural processing unit (NPU).

According to an embodiment, the piezo actuator 370 may provide a second signal to the processor 380 based on the pressure on the button 310. The main processor 381 may identify the second signal. The main processor 381 may identify a malfunction associated with the button 310 based on identifying the second signal while a first signal is not received. The main processor 381 may identify that the second signal and a third signal indicating an input on a button 330 are maintained during reference time based on the malfunction associated with the button 310. In response to identifying that the second signal and the third signal are maintained during the reference time, the main processor 381 may execute a function allocated to a combination of the pressure on the button 310 and the input on the button 330. For example, the function allocated to the combination of the pressure on the button 310 and the input on the button 330 may be associated with a reset of the electronic device 300. The main processor 381 may provide (or transmit) a control signal to power management circuitry 395 to perform the function allocated to the combination of the pressure on the button 310 and the input on the button 330.

According to an embodiment, in case that the malfunction of the main processor 381 occurs, the auxiliary processor 382 may perform a function associated with the at least one pressure sensor and the piezo actuator 370. In case that the malfunction of the main processor 381 occurs, an operation of the auxiliary processor 382 may correspond to operation 1201 to operation 1204 of FIG. 12.

Referring to FIG. 12, in operation 1201, the auxiliary processor 382 may identify whether an abnormal state of the main processor 381 has been identified. For example, since the auxiliary processor 382 operates as a backup in case that the abnormal state of the main processor 381 occurs, the auxiliary processor 382 may identify whether the abnormal state of the main processor 381 has been identified. Since the main processor 381 operates normally in case that the abnormal state of the main processor 381 is not identified, the auxiliary processor 382 may perform the operation 1201 according to a specified time period.

In operation 1202, the auxiliary processor 382 may identify whether a malfunction of a first button (e.g., the button 310) has been identified. For example, when an input on the first button and a third button is maintained during reference time, the processor 380 may be configured to perform the reset of the electronic device 300. In case that the abnormal state of the main processor 381 occurs, the reset of the electronic device 300 may not be performed. Therefore, the auxiliary processor 382 may identify the malfunction of the first button in order to perform the reset of the electronic device 300. For example, the auxiliary processor 382 may identify the malfunction of the first button based on identifying the second signal provided from the piezo actuator 370 while the first signal is not provided from a pressure sensor (e.g., the pressure sensor 361) corresponding to the first button.

According to an embodiment, in case that the malfunction of the first button is not identified, the auxiliary processor 382 may perform operation 1201. In case that the malfunction of the first button is not identified, the auxiliary processor 382 may perform operation 1201 according to the specified time period.

In operation 1203, in case that the malfunction of the first button is identified, the auxiliary processor 382 may identify whether the second signal and the third signal are maintained during the reference time. For example, the auxiliary processor 382 may identify that the second signal is provided from the piezo actuator 370 and identify the third signal provided according to an input of the third button. The auxiliary processor 382 may identify whether the second signal and the third signal are maintained during the reference time.

According to an embodiment, in case that the second signal and the third signal are not maintained during the reference time, the auxiliary processor 382 may perform operation 1203 again according to the specified time period.

In operation 1204, in case that the second signal and the third signal are maintained during the reference time, the auxiliary processor 382 may execute a function allocated to a combination of a pressure on the first button and an input on the third button. For example, the auxiliary processor 382 may transmit a control signal for controlling the power management circuitry 395 to the power management circuitry 395 to execute the function (e.g., the reset of the electronic device 300) allocated to the combination of the pressure on the first button and the input on the third button.

According to an embodiment, the power management circuitry 395 may perform the function (e.g., the reset of the electronic device 300) allocated to the combination of the pressure on the first button and the input on the third button according to whether the first signal and the third signal are maintained during the reference time. The auxiliary processor 382 may generate the first signal based on identifying the second signal provided from the piezo actuator 370 and provide the generated first signal to the power management circuitry 395. The power management circuitry 395 may identify whether the first signal and the third signal have been maintained during the reference time, and may also perform the function (e.g., the reset of the electronic device 300) allocated to the combination of the pressure on the first button and the input on the third button.

FIG. 13 is a cross-sectional view illustrating an example structure of a button assembly according to various embodiments.

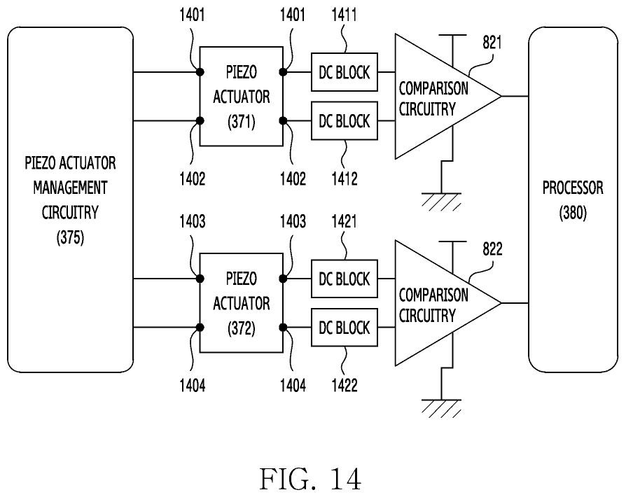

FIG. 14 is a diagram illustrating an example operation in which signals are provided from piezo actuators to a processor according to various embodiments.

Referring to FIG. 13, a button assembly 410 of an electronic device 300 may include two piezo actuators and two pressure sensors. For example, the button assembly 410 may include a piezo actuator 371 (e.g., a first piezo actuator) and a piezo actuator 372 (e.g., a second piezo actuator). The button assembly 410 may include a pressure sensor 361 and a pressure sensor 362.

According to an embodiment, the button assembly 410 may include a base frame 313, a first waterproof member 1361, a second waterproof member 1362, the piezo actuator 371, the piezo actuator 372, the pressure sensor 361, the pressure sensor 362, a support structure 1370, a printed circuit board 1380, a first elastic member 1368, and a second elastic member 1369. For example, the base frame 313 may correspond to the base frame 313 of FIG. 4B. The printed circuit board 1380 may correspond to the printed circuit board 423 of FIG. 4B.

According to an embodiment, the pressure sensor 361 and the pressure sensor 362 may be disposed under the printed circuit board 1380. The piezo actuator 371 and the piezo actuator 372 may be disposed on the printed circuit board 1380. The support structure 1370 may be disposed between the piezo actuator 371 (or the piezo actuator 372) and the printed circuit board 1380.

According to an embodiment, the base frame 313, the first waterproof member 1361, the piezo actuator 371, the pressure sensor 361, and the first elastic member 1368 may be disposed for a button 310. For example, the base frame 313, the second waterproof member 1362, the piezo actuator 372, the pressure sensor 362, and the second elastic member 1369 may be disposed for a button 330.

For example, the first waterproof member 1361 may be coupled to a portion of the base frame 313. The first waterproof member 1361 may be disposed between the portion of the base frame 313 and the piezo actuator 371. The first waterproof member 1361 may prevent/block a foreign substance such as dust and/or moisture from being introduced into the piezo actuator 371.

For example, the second waterproof member 1362 may be coupled to another portion of the base frame 313. The second waterproof member 1362 may be disposed between the other portion of the base frame 313 and the piezo actuator 372. The second waterproof member 1362 may prevent/block a foreign substance such as dust and/or moisture from being introduced into the piezo actuator 372.

According to an embodiment, a pressure on an area (e.g., the area 341 of FIG. 3A) of the base frame 313 corresponding to the pressure sensor 361 may be transmitted to the piezo actuator 371 and/or the pressure sensor 361 via the first waterproof member 1361.

According to an embodiment, a pressure on another area (e.g., the area 343 of FIG. 3A) of the base frame 313 corresponding to the pressure sensor 362 may be transmitted to the piezo actuator 372 and/or the pressure sensor 362 via the second waterproof member 1362.

According to an embodiment, the piezo actuator 371 may be disposed between the pressure sensor 361 and the base frame 313. The piezo actuator 371 may be configured to output a vibration (or haptic feedback) based on the pressure on the area (e.g., the area 341 of FIG. 3A) of the base frame 313. The pressure on the area (e.g., the area 341 of FIG. 3A) of the base frame 313 may be generated by a user input. The user input on the area (e.g., the area 341 of FIG. 3A) of the base frame 313 may include a gesture input and/or a press input. For example, a vibration pattern output via the piezo actuator 371 may be changed according to the user input on the area (e.g., the area 341 of FIG. 3A) of the base frame 313.

According to an embodiment, the piezo actuator 372 may be disposed between the pressure sensor 362 and the base frame 313. The piezo actuator 372 may be configured to output a vibration (or haptic feedback) based on the pressure on the other area (e.g., the area 343 of FIG. 3A) of the base frame 313. The pressure on the other area (e.g., the area 343 of FIG. 3A) of the base frame 313 may be generated by a user input. The user input on the other area (e.g., the area 343 of FIG. 3A) of the base frame 313 may include a gesture input and/or a press input. For example, a vibration pattern output via the piezo actuator 372 may be changed according to the user input on the other area (e.g., the area 343 of FIG. 3A) of the base frame 313.

According to an embodiment, the first elastic member 1368 may be disposed such that a portion of the base frame 313 corresponding to the area (e.g., the area 341) of the base frame 313 is inserted into the housing 301 according to the pressure on the area of the base frame 313. According to an embodiment, the second elastic member 1369 may be disposed such that another portion of the base frame 313 corresponding to the other area (e.g., area 343) of the base frame 313 is inserted into the housing 301 according to the pressure on the other area of the base frame 313.

Referring to FIG. 14, the piezo actuator 371 and the piezo actuator 372 may be connected to a processor 380. The processor 380 may be connected to the piezo actuator 371 and/or the piezo actuator 372 via piezo actuator management circuitry 375 to output a vibration via the piezo actuator 371 and/or the piezo actuator 372. The processor 380 may be connected to the piezo actuator management circuitry 375 via a path 1430. The piezo actuator management circuitry 375 may be connected to the piezo actuator 371 and/or the piezo actuator 372.

According to an embodiment, the piezo actuator 371 may be connected to the processor 380 via DC blocks 1411 and 1412 and comparison circuitry 821 to provide (or transmit or output) a signal indicating that a pressure on the button 310 is identified.

According to an embodiment, the piezo actuator 372 may be connected to the processor 380 via DC blocks 1421 and 1422 and comparison circuitry 822 to provide (or transmit or output) a signal indicating that a pressure on a button 320 is identified.

According to an embodiment, the piezo actuator 371 may include a first terminal 1401 and a second terminal 1402. For example, the first terminal 801 may be connected to the DC block 1411. The first terminal 1401 may be connected to the piezo actuator management circuitry 375. For example, the second terminal 1402 may be connected to the DC block 1412. The second terminal 1402 may be connected to the piezo actuator management circuitry 375. According to an embodiment, the piezo actuator 371 may be connected to the DC block 1411 and the piezo actuator management circuitry 375 via different terminals. According to an embodiment, the piezo actuator 371 may be connected to the DC block 1412 and the piezo actuator management circuitry 375 through different terminals.

According to an embodiment, the piezo actuator 372 may include a third terminal 1403 and a fourth terminal 1404. For example, the third terminal 1403 may be connected to the DC block 1421. The third terminal 1403 may be connected to the piezo actuator management circuitry 375. For example, the fourth terminal 1404 may be connected to the DC block 1422. The fourth terminal 1404 may be connected to the piezo actuator management circuitry 375. According to an embodiment, the piezo actuator 372 may be connected to the DC block 1421 and the piezo actuator management circuitry 375 through different terminals. According to an embodiment, the piezo actuator 372 may be connected to the DC block 1422 and the piezo actuator management circuitry 375 through different terminals.

According to an embodiment, the processor 380 may apply a voltage for outputting a vibration to the piezo actuator 371 via the first terminal 1401 and the second terminal 1402. Based on the applied voltage, the piezo actuator 371 may output the vibration.

According to an embodiment, the processor 380 may apply a voltage for outputting a vibration to the piezo actuator 372 via the third terminal 1403 and the fourth terminal 1404. Based on the applied voltage, the piezo actuator 372 may output the vibration.

According to an embodiment, a voltage difference between the first terminal 1401 and the second terminal 1402 may be changed based on the pressure on the button 310. For example, since the piezo actuator 371 is a piezoelectric element, the voltage difference between the first terminal 1401 and the second terminal 1402 may be changed based on a pressure on the button 310 and/or the button 330.

For example, the DC block 1411 may provide a direct current (DC) voltage of the first terminal 1401 to the comparison circuitry 821. The DC block 1412 may provide a DC voltage of the second terminal 1402 to the comparison circuitry 821. The comparison circuitry 821 may identify a voltage difference between the DC voltage of the first terminal 1401 and the DC voltage of the second terminal 1402. For example, the comparison circuitry 821 may be configured to output a signal based on the voltage difference between the first terminal 1401 and the second terminal 1402. As an example, in case that the voltage difference between the first terminal 1401 and the second terminal 1402 is within a reference voltage range, the comparison circuitry 821 may output the signal. In case that the voltage difference between the first terminal 1401 and the second terminal 1402 is out of a reference voltage, the comparison circuitry 821 may refrain from outputting the signal.

For example, based on the pressure on the button 310, the voltage difference between the first terminal 1401 and the second terminal 1402 may be changed within the reference voltage range. Therefore, the comparison circuitry 821 may output a signal based on the pressure on the button 310. The signal may be provided to the processor 380. The signal may indicate that the pressure is applied to the button 310.

According to an embodiment, a voltage difference between the third terminal 1403 and the fourth terminal 1404 may be changed based on the pressure on the button 320. For example, since the piezo actuator 371 is the piezoelectric element, the voltage difference between the third terminal 1403 and the fourth terminal 1404 may be changed based on the pressure on the button 320.

For example, the DC block 1411 may provide a direct current (DC) voltage of the third terminal 1403 to the comparison circuitry 822. The DC block 1412 may provide a DC voltage of the fourth terminal 1404 to the comparison circuitry 822. The comparison circuitry 822 may identify a voltage difference between the DC voltage of the third terminal 1403 and the DC voltage of the fourth terminal 1404. For example, the comparison circuitry 822 may be configured to output a signal based on the voltage difference between the third terminal 1403 and the fourth terminal 1404. As an example, in case that the voltage difference between the third terminal 1403 and the fourth terminal 1404 is within a reference voltage range, the comparison circuitry 822 may output the signal. In case that the voltage difference between the third terminal 1403 and the fourth terminal 1404 is out of a reference voltage, the comparison circuitry 822 may refrain from outputting the signal.

For example, based on the pressure on the button 320, the voltage difference between the third terminal 1403 and the fourth terminal 1404 may be changed within the reference voltage range. Therefore, the comparison circuitry 822 may output a signal based on the pressure on the button 320. The signal may be provided to the processor 380. The signal may indicate that the pressure is applied to the button 320.

According to an example embodiment, an electronic device (e.g., the electronic device 300) may include a housing (e.g., the housing 301), a first button (e.g., the button 310), a second button (e.g., the button 320), and a third button (e.g., the button 330) disposed on a side surface of the housing, a first pressure sensor (e.g., the pressure sensor 361) for sensing a first pressure on the first button, a second pressure sensor (e.g., the pressure sensor 362) for sensing a second pressure on the second button, a switch circuit (e.g., the switch 363) for sensing an input on the third button, a vibration element (e.g., the piezo actuator 370) configured to output a vibration based on at least one of the first pressure or the second pressure, disposed between the first pressure sensor and the second pressure sensor, at least one processor (e.g., the processor 380) comprising processing circuitry, memory (e.g., the memory 390) comprising one or more storage media, storing instructions.

The instructions, when executed by the at least one processor individually or collectively, may cause the electronic device to identify whether a first signal is provided from the first pressure sensor to the at least one processor according to the first pressure, identify an input on the first button based on the first signal provided from the first pressure sensor to the at least one processor according to the first pressure, detect a malfunction associated with the first button based on receiving a second signal from the vibration element while the first signal is not provided to the at least one processor from the first pressure sensor, and based on the malfunction associated with the first button, in response to the second signal and a third signal indicating the input on the third button being maintained during reference time, execute a function allocated to a combination of the first pressure on the first button and the input on the third button.

For example, the electronic device may include a button assembly for the first button and the second button. The button assembly may include a base frame including a protrusion unit formed to protrude from the side surface of the housing, a first rubber for cushioning an impact, under the base frame, and a second rubber for waterproof from an outside of the housing, connected to the first rubber.

For example, the first button may be defined based on a first portion of the base frame. The second button may be defined based on a second portion of the base frame.

For example, the vibration element may include a first terminal and a second terminal. A voltage difference between the first terminal and the second terminal may be changed based on the first pressure on the first button.

For example, the electronic device may include comparison circuitry for connecting the vibration element and the at least one processor, configured to output the second signal based on the voltage difference between the first terminal and the second terminal of the vibration element.

For example, the comparison circuitry may be configured to, in case that the voltage difference between the first terminal and the second terminal is within a reference voltage range, output the second signal, and in case that the voltage difference between the first terminal and the second terminal is out of the reference voltage range, refrain from outputting the second signal.

For example, the instructions, when executed by the at least one processor individually or collectively, may cause the electronic device to, based on identification of the first signal, apply, via the first terminal and the second terminal, a voltage for outputting the vibration to the vibration element, and while the first signal is not provided to the at least one processor from the first pressure sensor, refrain from applying, via the first terminal and the second terminal, the voltage for outputting the vibration to the vibration element.

For example, the instructions, when executed by the at least one processor individually or collectively, may cause the electronic device to, based on the first signal provided from the first pressure sensor to the at least one processor, in response to the first signal and the third signal being maintained during the reference time, execute the function.

For example, the instructions, when executed by the at least one processor individually or collectively, may cause the electronic device to, based on identification of the first signal, identify that a function allocated to the first pressure on the first button is not executed during a reference time interval, and based on identifying that the function allocated to the first pressure on the first button is not executed during the reference time interval, detect the malfunction associated with the first button.

For example, the electronic device may include power management circuitry. The function may be associated with a reset of the electronic device. The instructions, when executed by the at least one processor individually or collectively, may cause the electronic device to provide a control signal to the power management circuitry to execute the function.

For example, the first pressure sensor may be disposed under the first button. The second pressure sensor may be disposed under the second button.

According to an embodiment, a method performed by an electronic device may include identifying whether a first signal is provided from a first pressure sensor to at least one processor of the electronic device according to a first pressure on a first button among the first button, a second button, and a third button, identifying an input on the first button based on the first signal provided from the first pressure sensor to the at least one processor according to the first pressure, detecting a malfunction associated with the first button based on receiving a second signal from a vibration element of the electronic device while the first signal is not provided to the at least one processor from the first pressure sensor, and based on the malfunction associated with the first button, in response to the second signal and a third signal indicating an input on the third button being maintained during reference time, executing a function allocated to a combination of the pressure on the first button and the input on the third button.

For example, an electronic device may include a vibration element. The vibration element may include a first terminal and a second terminal.

For example, a voltage difference between the first terminal and the second terminal may be changed based on the pressure on the first button. The electronic device may include comparison circuitry for connecting the vibration element and the at least one processor, configured to output the second signal based on the voltage difference between the first terminal and the second terminal of the vibration element.

For example, the comparison circuitry may be configured to, in case that the voltage difference between the first terminal and the second terminal is within a reference voltage range, output the second signal, and in case that the voltage difference between the first terminal and the second terminal is out of the reference voltage range, refrain from outputting the second signal.

For example, the method may include, based on identification of the first signal, applying, via the first terminal and the second terminal, a voltage for outputting the vibration to the vibration element, and while the first signal is not provided to the at least one processor from the first pressure sensor, refraining from applying, via the first terminal and the second terminal, the voltage for outputting the vibration to the vibration element.

For example, the method may include, based on the first signal provided from the first pressure sensor to the at least one processor, in response to the first signal and the third signal being maintained during the reference time, executing the function.

For example, the method may include, based on identification of the first signal, identifying that a function allocated to the first pressure on the first button is not executed during a reference time interval, and based on identifying that the function allocated to the first pressure on the first button is not executed during the reference time interval, detecting the malfunction associated with the first button.

For example, the electronic device may include power management circuitry. The function may be associated with a reset of the electronic device. The method may include providing a control signal to the power management circuitry to execute the function.

For example, the first pressure sensor may be disposed under the first button. The second pressure sensor may be disposed under the second button.

According to an embodiment, an electronic device may include a housing, a first button and a second button disposed on a side surface of the housing, a display disposed a front surface of the housing, a first pressure sensor for sensing a first pressure on the first button, a second pressure sensor for sensing a second pressure on the second button, a vibration element configured to output a vibration based on the first pressure or the second pressure, disposed between the first pressure sensor and the second pressure sensor, at least one processor comprising processing circuitry, and memory comprising one or more storage media, storing instructions. The instructions, when executed by the at least one processor individually or collectively, may cause the electronic device to identify, using the first pressure sensor, the first pressure on the first button, based on identifying the first pressure, output, using the vibration element, a first vibration corresponding to the first pressure, identify, using the second pressure sensor, the second pressure on the second button, and based on identifying the second pressure, output, using the vibration element, a second vibration corresponding to the second pressure.

For example, the instructions, when executed by the at least one processor individually or collectively, may cause the electronic device to, in case that the first pressure on the first button is not identified using the first pressure sensor and a third pressure on the first button is identified using the vibration element, identify malfunction associated with the first button.

For example, the instructions, when executed by the at least one processor individually or collectively, may cause the electronic device to, in case that the second pressure on the second button is not identified using the second pressure sensor and a fourth pressure on the second button is identified using the vibration element, identify malfunction associated with the second button.

For example, the instructions, when executed by the at least one processor individually or collectively, may cause the electronic device to, based on identifying malfunction of at least one of the first button or the second button, display, via the display, a user interface indicating the malfunction.

For example, the electronic device may further include a third button disposed on the side surface of the housing, and a switch circuit for sensing an input on the third button. The instructions, when executed by the at least one processor individually or collectively, may cause the electronic device to, while identifying the malfunction associated with the first button, identify, using the vibration element, the third pressure on the first button, and identify, using the switch circuit, the input on the third button, and in response to the third pressure and the input being maintained during reference time, reset the electronic device.

For example, the vibration element may include a first terminal and a second terminal. A voltage difference between the first terminal and the second terminal may be changed based on the third pressure on the first button.

For example, the electronic device may include comparison circuitry for connecting the vibration element and the at least one processor, configured to identify the third pressure on the first button based on the voltage difference between the first terminal and the second terminal of the vibration element.

For example, the comparison circuitry may configured to, in case that the voltage difference between the first terminal and the second terminal is within a reference voltage range, output a signal indicating the third pressure on the first button, and in case that the voltage difference between the first terminal and the second terminal is out of the reference voltage range, refrain from outputting the signal.

For example, the electronic device may further include a third button disposed on the side surface of the housing, and a switch circuit for sensing an input on the third button. The instructions, when executed by the at least one processor individually or collectively, may cause the electronic device to, in response to the first pressure on the first button and the input on the third button being maintained during reference time, reset the electronic device.

For example, the instructions, when executed by the at least one processor individually or collectively, may cause the electronic device to, based on identifying, via the vibration element, a third pressure on the first button, identify that a function allocated to the first pressure on the first button is not executed during a reference time interval, and based on identifying that the function allocated to the first pressure on the first button is not executed during the reference time interval, detect malfunction associated with the first button.

For example, the first pressure sensor may be disposed under the first button. The second pressure sensor may be disposed under the second button.

For example, the electronic device may include a button assembly for the first button and the second button. The button assembly may include a base frame including a protrusion unit formed to protrude from the side surface of the housing, a first rubber for cushioning an impact, under the base frame, and a second rubber for waterproof from an outside of the housing, connected to the first rubber.

For example, the first button may be defined based on a first portion of the base frame. The second button may be defined based on a second portion of the base frame.

According to an embodiment, a method performed by an electronic device may include identifying, using a first pressure sensor of the electronic device, a first pressure on a first button among the first button and a second button of the electronic device, based on identifying the first pressure, outputting, using a vibration element of the electronic device, a first vibration corresponding to the first pressure, identifying, using a second pressure sensor of the electronic device, the second pressure on the second button, and based on identifying the second pressure, outputting, using the vibration element, a second vibration corresponding to the second pressure.

For example, the method may include, in case that the first pressure on the first button is not identified using the first pressure sensor and a third pressure on the first button is identified using the vibration element, identifying malfunction associated with the first button.

For example, the method may include, in case that the second pressure on the second button is not identified using the second pressure sensor and a fourth pressure on the second button is identified using the vibration element, identifying malfunction associated with the second button.

For example, the method may include, based on identifying malfunction of at least one of the first button or the second button, displaying, via a display of the electronic device, a user interface indicating the malfunction.

For example, the method may include, while identifying the malfunction associated with the first button, identifying, using the vibration element, the third pressure on the first button, and identifying, using a switch circuit of the electronic device, the input on the third button, and in response to the third pressure and the input being maintained during reference time, resetting the electronic device.

For example, the vibration element may include a first terminal and a second terminal. A voltage difference between the first terminal and the second terminal may be changed based on the third pressure on the first button.

For example, the method may include, in response to the first pressure on the first button and an input on a third button of the electronic device identified via a switch circuit of the electronic device being maintained during reference time, resetting the electronic device.

According to the above-described embodiment, a first button (e.g., the button 310) of an electronic device may be configured as a digital button including a pressure sensor (e.g., the pressure sensor 361). In case that the first button is configured as the digital button, an input on the first button may not be identified, in case that a malfunction of the first button occurs. In case that a pressure (or an input) is applied to the first button and a third button (e.g., the button 330) during reference time, a reset of an electronic device 300 may be performed. Since the pressure on the first button may not be identified in case that the malfunction of the first button occurs, the electronic device 300 may identify whether the pressure is applied to the first button using a piezo actuator. The electronic device may identify that the pressure is applied to the first button via a second signal provided via the piezo actuator. Accordingly, the electronic device may perform a reset of the electronic device based on identifying that the pressure on the first button and the input on the third button are maintained during the reference time.

The electronic device may identify the pressure on the first button via the piezo actuator and the pressure sensor. The piezo actuator may perform an auxiliary function of the pressure sensor. In addition, since the electronic device may identify the pressure on the first button via the piezo actuator and the pressure sensor, accuracy of the input may increase.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), the element may be coupled with the other element directly (e.g., wiredly), wirelessly, or via a third element.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

No claim element is to be construed under the provisions of 35 U.S.C. § 112, sixth paragraph, unless the element is expressly recited using the phrase “means for” or “means.”

What is claimed is:

1. An electronic device comprising:
a housing;
a first button and a second button disposed on a side surface of the housing;
a display disposed at a front surface of the housing;
a first pressure sensor configured to sense a first pressure on the first button;
a second pressure sensor configured to sense a second pressure on the second button;
a vibration element configured to output a vibration based on the first pressure or the second pressure, disposed between the first pressure sensor and the second pressure sensor;
at least one processor comprising processing circuitry; and
memory comprising one or more storage media, storing instructions,
wherein the instructions, when executed by the at least one processor individually or collectively, cause the electronic device to:
identify, using the first pressure sensor, the first pressure on the first button,
based on identifying the first pressure, output, using the vibration element, a first vibration corresponding to the first pressure,
identify, using the second pressure sensor, the second pressure on the second button, and
based on identifying the second pressure, output, using the vibration element, a second vibration corresponding to the second pressure.

2. The electronic device of claim 1, wherein the instructions, when executed by the at least one processor individually or collectively, cause the electronic device to:
in case that the first pressure on the first button is not identified using the first pressure sensor and a third pressure on the first button is identified using the vibration element, identify malfunction associated with the first button.

3. The electronic device of claim 2, wherein the instructions, when executed by the at least one processor individually or collectively, cause the electronic device to:
in case that the second pressure on the second button is not identified using the second pressure sensor and a fourth pressure on the second button is identified using the vibration element, identify malfunction associated with the second button.

4. The electronic device of claim 3, wherein the instructions, when executed by the at least one processor individually or collectively, cause the electronic device to:
based on identifying malfunction of at least one of the first button or the second button, display, via the display, a user interface indicating the malfunction.

5. The electronic device of claim 2, wherein the electronic device further comprises:
a third button disposed on the side surface of the housing, and
a switch circuit for sensing an input on the third button; and
wherein the instructions, when executed by the at least one processor individually or collectively, cause the electronic device to:
while identifying the malfunction associated with the first button:
identify, using the vibration element, the third pressure on the first button, and
identify, using the switch circuit, the input on the third button, and
in response to the third pressure and the input being maintained during reference time, reset the electronic device.

6. The electronic device of claim 2, wherein the vibration element comprises a first terminal and a second terminal, and
wherein a voltage difference between the first terminal and the second terminal, is changed based on the third pressure on the first button.

7. The electronic device of claim 6, wherein the electronic device further comprises comparison circuitry for connecting the vibration element and the at least one processor, configured to identify the third pressure on the first button based on the voltage difference between the first terminal and the second terminal of the vibration element.

8. The electronic device of claim 7, wherein the comparison circuitry is configured to:
in case that the voltage difference between the first terminal and the second terminal is within a reference voltage range, output a signal indicating the third pressure on the first button, and
in case that the voltage difference between the first terminal and the second terminal is out of the reference voltage range, refrain from outputting the signal.

9. The electronic device of claim 1, wherein the electronic device further comprises:
a third button disposed on the side surface of the housing, and
a switch circuit for sensing an input on the third button; and
wherein the instructions, when executed by the at least one processor individually or collectively, cause the electronic device to:
in response to the first pressure on the first button and the input on the third button being maintained during reference time, reset the electronic device.

10. The electronic device of claim 1, wherein the instructions, when executed by the at least one processor individually or collectively, cause the electronic device to:
based on identifying, via the vibration element, a third pressure on the first button, identify that a function allocated to the first pressure on the first button is not executed during a reference time interval, and
based on identifying that the function allocated to the first pressure on the first button is not executed during the reference time interval, detect malfunction associated with the first button.

11. The electronic device of claim 1, wherein the first pressure sensor is disposed under the first button; and
wherein the second pressure sensor is disposed under the second button.

12. The electronic device of claim 1, wherein the electronic device comprises a button assembly for the first button and the second button;
wherein the button assembly further comprises:
a base frame including a protrusion unit formed to protrude from the side surface of the housing;
a first rubber for cushioning an impact, under the base frame; and
a second rubber for waterproof from an outside of the housing, connected to the first rubber.

13. The electronic device of claim 12, wherein the first button is defined based on a first portion of the base frame, and
wherein the second button is defined based on a second portion of the base frame.

14. A method performed by an electronic device, comprising:
identifying, using a first pressure sensor of the electronic device, a first pressure on a first button among the first button and a second button of the electronic device,
based on identifying the first pressure, outputting, using a vibration element of the electronic device, a first vibration corresponding to the first pressure,
identifying, using a second pressure sensor of the electronic device, the second pressure on the second button, and
based on identifying the second pressure, outputting, using the vibration element, a second vibration corresponding to the second pressure.

15. The method of claim 14, wherein the method comprises:
in case that the first pressure on the first button is not identified using the first pressure sensor and a third pressure on the first button is identified using the vibration element, identifying malfunction associated with the first button.

16. The method of claim 15, wherein the method comprises:
in case that the second pressure on the second button is not identified using the second pressure sensor and a fourth pressure on the second button is identified using the vibration element, identifying malfunction associated with the second button.

17. The method of claim 16, wherein the method comprises:
based on identifying malfunction of at least one of the first button or the second button, displaying, via a display of the electronic device, a user interface indicating the malfunction.

18. The method of claim 15, wherein the method comprises:
while identifying the malfunction associated with the first button:
identifying, using the vibration element, the third pressure on the first button, and
identifying, using a switch circuit of the electronic device, the input on the third button, and
in response to the third pressure and the input being maintained during reference time, resetting the electronic device.

19. The method of claim 15, wherein the vibration element comprises a first terminal and a second terminal, and
wherein a voltage difference between the first terminal and the second terminal, is changed based on the third pressure on the first button.

20. The method of claim 14, wherein the method comprises:
in response to the first pressure on the first button and an input on a third button of the electronic device identified via a switch circuit of the electronic device being maintained during reference time, resetting the electronic device.
